(19) United States
(12) Patent Application Publication
(10) Pub. No.: US 2013/0151551 A1
(43) Pub. Date: Jun. 13, 2013

(54) COMPUTER-IMPLEMENTED METHOD OF GEOMETRIC FEATURE DETECTION

(71) Applicants: Peter Chow, Kent (GB); Tetsuyuki Kubota, Kawasaki (JP); Makoto Sakairi, Kawasaki (JP)

(72) Inventors: Peter Chow, Kent (GB); Tetsuyuki Kubota, Kawasaki (JP); Makoto Sakairi, Kawasaki (JP)

(21) Appl. No.: 13/516,493

(22) PCT Filed: Dec. 22, 2010
(86) PCT No.: PCT/EP2010/070605

§ 371 Date: Jan. 18, 2013

(30) Foreign Application Priority Data
Dec. 23, 2009 (EP) 09180687.7

(51) Int. Cl. G06F 17/30

(52) U.S. Cl. CPC G06F 17/30657
USPC 707/769

(57) ABSTRACT

A computer-implemented method of geometric feature detection comprising accessing a data file including a geometric model of an object; accessing an unsuitable feature file including definitions of geometric features which are unsuitable for analysis; automatically detecting a defined unsuitable geometric feature included in the object; and optionally modifying the unsuitable geometric feature to produce a modified model for analysis purposes.

The present invention relates to computer-aided design and engineering. In particular it relates to adaptation of a model created of an object in a computer environment, in order to render that model more suitable for analysis.

This modification process is most commonly found in design and manufacturing processes. For example, an engineer may design a product prototype in the form of a component or complex part using a model in a CAD (computer-aided design) package such as AUTO CAD or Pro/ENGINEER and then wish to test the model for suitability of use. Such analysis of the virtual prototype/model may be required for specification requirements such as durability, health and safety demands and manufacturability. The design engineer may for instance wish to analyse the model in simulations to determine heat resistance, propagation of electromagnetic or other fields or stress-strain properties. This simulation process can refine product design without entailing the cost of actual manufacture and physical test. However, it is often necessary to modify the model so that it is simplified and can be more easily analysed.

One particular application of a modification process for a geometric model is in simplification of architectural models of buildings, for example for providing/improving airflow or ventilation or for fire simulation. Modification before thermal cooling simulation of models for heat producing electronic devices such as computer servers and mobile communications devices is a further, specific application.

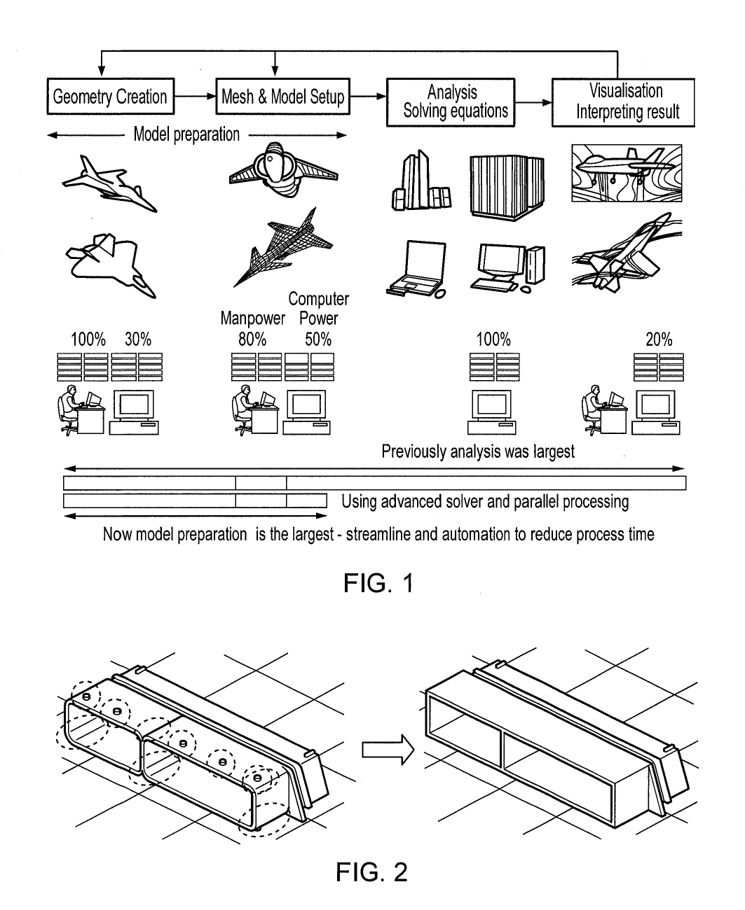

FIG. 1 shows an overview of the simulation process chain frequently found in design and manufacturing processes. The primary stages are as follows:
1. Geometry Creation: this is creating a geometric model in the spatial domain. Models are commonly created using a Computer-Aided Design (CAD) system. If the CAD model is not correct, for example does not define a watertight solid or uses multiple definitions to cover a single plane, a CAD repair/merge stage may be required.
2. Model Setup: this is preparation, for example model modification, mesh generation and setup of model analysis conditions. Using an un-modified model directly for analysis is possible but comes at a great expense in computing resources and analysis time. The common practice in industry is to include an intermediate stage called CAD-to-CAE model preparation (CCMP). This significantly reduces the model size (in terms of electronic storage) and prepares the model for various classes of analysis. Models usually require preparation in form of modification (sometimes known as defeaturing) to make them suitable for analysis/simulation. Until recently the CCMP stage has been labour intensive and largely a manual process. With the development of computer-aided tools that automatically detect and process features, efficiency has significantly improved. The next step in model set up is mesh generation. Automatic and fast mesh generation is available for both structured (finite difference) and unstructured (finite element) meshes. The final step, setting of model analysis conditions, is dependent on the type of analysis, such as heat flow analysis, fluid flow analysis and stress analysis.
3. Analysis: this is using a computer system to undertake simulation and analysis. Analysis may include calculation to numerical solution of properties such as mechanical stress, fluid flow and electromagnetic properties which are important in design and manufacturing. In the case of electronic products, the common analyses are finite element analysis (FEA) of stress/strain (in drop/crash tests), electromagnetic interference and thermal-fluid cooling. Analysis used to be the most time consuming stage in the entire process but using parallel processing and advanced numerical methods this is no longer the case. With stages 2 and 4, analysis is referred to as Computer-Aided Engineering (CAE).
4. Visualisation: this is the opportunity to view and interpret analysis results. Commonly, 3D animations and plots of field values against specific parameters such as time, energy, etc. are used to aid engineers and designers.

Today, the most time consuming elements in CAD/CAE are usually in the model preparation processing (CCMP). In the automobile industry it is reported to be over 80 percent of the total time. A significant part of this is to do with modifying CAD models to make them suitable for a specific type of CAE application. If we can introduce automation and streamlining into the procedure and process, then further efficiency improvements can be achieved.

The linkage of CAD and CAE is a recent event. There are many incompatibilities and challenges that need to be overcome. A general solution to the problem is not near the horizon due to the many CAD systems and many more CAE applications. Obviously a tight coupling between CAD and CAE would provide a good solution to model modification and shorten the CAE processing time. In the case of simplification, non-essential features could then be specified in the CAD system which thus can output models precisely for a particular CAE application. This is only feasible given full control of the CAD model creation history and CAE applications.

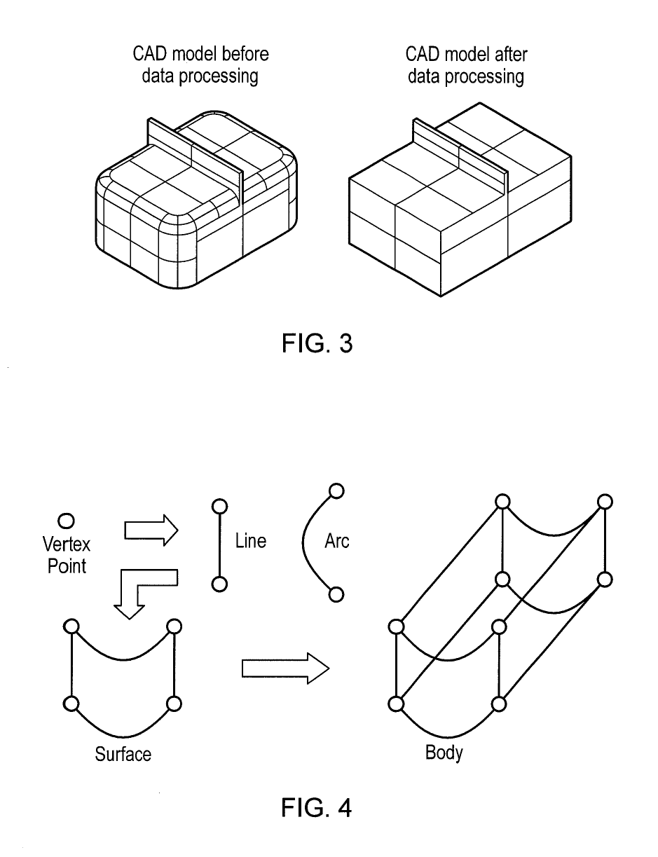

To give an idea of the sort of modifications which may be applied, FIGS. 2 and 3 show some examples of CAD models before and after simplification. In FIG. 2, the original model is shown on the left, while one resulting from removing small features and blend (radius) simplification is on the right. Far fewer and simpler elements are required to represent the modified geometry. FIG. 3 has the same “before and after” arrangement, from which it can be seen that the modified model on the right requires fewer and simpler elements to represent it than the full model shown on the left. This will lead to shorter analysis time.

The advantages of not including non-essential and small features can be that the reduced model size in the mesh leads to shorter analysis; and/or that, for transient simulation, bigger time-step sizes can be used, leading to a smaller number of time-steps for any required time interval and thus shorter analysis time.

In situations where the CAD models are from third parties and/or multiple CAD systems are involved then it is very complicated to remove or modify non-essential features. This is because model creation history is not contained in the CAD model file, only the spatial geometric description in the basic elements of vertex point, line, arc, surface, body, and their topology relationship. FIG. 4 shows the basic geometric elements as an example, in which points are joined by straight lines/arcs to form a surface (or surface element) and surfaces are combined to form a body. In the special case of a cylinder, no vertex points are necessarily required. Some CAD packages support the full definition of a cylinder without vertex points. Other CAD packages do not and instead use a definition of two half-cylindrical surfaces, allowing the introduction of vertex points for each and every geometric surface defined.

The related art strategies to address the CAD-to-CAE model in the situation that the CAD model does not specify which geometric features are non-essential and unsuitable for analysis are:
1. Surface wrapping: this is effectively shrink-wrapping a surface mesh onto a geometric model, in a manner which can be visualised as wrapping “cling film” over the model, closing holes, joining disconnected and overlapping surfaces, minimising small features and so on, to provide a single continuous and generally smooth surface. This can be fully automated but is not suitable for structured meshes (such as finite difference meshes), at least partly because it tends to produce geometrically complex surfaces and curves.
2. Removing and/or modifying geometric features in the CAD model. This strategy offers the most flexible solution and is suitable for all CAE applications. In the related art it is currently possible to automatically detect circular-section through-holes, blends and chamfers using a software tool, and to use the same tool to remove these features, as long as they are not present in conjunction with other features. Other (for example more intricate) features cannot be automatically handled and manual model modification is required. This is a major deficiency for industrial models/applications such as those in electronic product design and development. The main difficulty here is in detection of the features for processing. Once the features have been detected, the processing (for example with Boolean operators) can be relatively straightforward compared to detection.

In situations where automatic/computerised detection is not available, detection must be manually specified or new features must be individually specified (for example using basic geometric definitions) within the code for the software tool, if possible. This task is labour intensive and time consuming, particularly for code which must be complied, such as C++.

It is thus desirable to eliminate or at least mitigate some of the disadvantages of the prior art to allow automatic modification of a geometric model in an efficient way.

### STATEMENTS OF INVENTION

An embodiment of a first aspect of the invention provides a computer-implemented method of geometric feature detection comprising accessing a data file including a geometric model of an object; accessing an unsuitable feature file including definitions of geometric features which are unsuitable for analysis; and automatically detecting a defined unsuitable geometric feature included in the object.

The method of these invention embodiments uses an unsuitable feature file which is accessed during the method. The unsuitable feature file includes definition of the geometric features which are unsuitable for analysis. Providing this unsuitable feature file which can be accessed during the method is advantageous in that it allows a file to be created specifically for the unsuitable features. Hence additions can be made to the geometric features for detection without access, for example, to source code for the computer program executing the method. This can allow not only developers of the method but also users of the method to add new features and revise existing ones without the danger that this might damage the method source code. The data required for automatic feature detection and processing can be a simple data file which is read into the program executing the method at run time.

It is noted that invention embodiments extend to methods in which some user input is required and also to more or less automatic methods. Thus for example in a “batch-processing” fully automatic method, all of the features of the invention embodiments as set out above can be carried out by the computer without manual input. This is well suited for high-performance, high-efficiency processing. In other embodiments, some steps/processes are carried out with input from the user. For example, the user may specify which data file is to be accessed. The step of automatically detecting an unsuitable feature (and the step of modifying the feature) is to be carried out by the computer, but a user might employ a graphical user interface (GUI) to preselect a certain type of geometric feature and to accept or reject a modification which is automatically provided. Methods with more manual input are well suited to handle queries about the model and difficult detection scenarios.

Any kind of suitable definition(s) can be used in the unsuitable feature file. Preferably however the definitions are formulated in a way that allows easy addition of new definitions. In one embodiment, a shared hierarchy of feature characteristics is used in the unsuitable feature file for the definitions of at least two unsuitable features, at least a base feature characteristic in the hierarchy being present in the two unsuitable features. The principle here is that many geometric features share basic feature characteristics and such basic feature characteristics can be used in two or more different unsuitable features. The shared hierarchy can simplify conceptualization of new features by the person adding them, save storage space for the unsuitable feature file and improve ease of use of the file as well as accuracy and reproducibility of the results.

One way of constructing the shared hierarchy of feature characteristics is to use a “tree” structure. A tree structure shows the hierarchical nature of the structure in a graphical form. For example, there is a single root or root node which forms the starting point of the structure and further nodes stem hierarchically from the route node.

In some invention embodiments, the definitions of unsuitable geometric features are constructed as a hierarchical tree allowing querying during the detection of an unsuitable geometric feature, with at least some query outcomes representing defined unsuitable geometric features, and wherein a query as to a base feature characteristic forms a first query leading to a first outcome and a further query as to a further feature characteristic (for example which is present in a subset of features having the base feature characteristic) is appended to the first outcome, leading to a further query outcome. In this case, the query outcomes could be viewed as some of the tree nodes.

The skilled reader will appreciate that such a hierarchical tree may be constructed in a number of different ways. For example the queries may be yes/no queries with one tree branch for yes and another for no, or three or more different queries may stem from a single node, for example to represent three different possible further feature characteristics each of which might result in or lead in the direction of a separate undesirable geometric feature.

The queries themselves may be written into the tree (for example, “is there a single cylinder surface present?”) or the queries may be part of the method so that the tree itself has an element corresponding to a single cylinder surface (using the same example) and the detection method checks whether the feature is present or not. This is a matter of individual implementation.

In some embodiments, automatically detecting includes applying hierarchical queries to the model to check it against the unsuitable geometric features defined in the tree. For example this may involve checking the faces of the model in turn using the tree.

As all will be explained in more detail later, the various component parts of a more complex model can be processed separately and features identified in a specific advantageous order on a per-component basis.

The base feature characteristic (which can form the root node of a hierarchical tree) can be any suitable for the geometric model in question. For example a base feature characteristic may be the footprint of a protrusion, cavity or through-hole projecting from a surface of the model. This footprint may be a “hole” on a surface which indicates either an actual hole or a protrusion from that surface. A further feature characteristic may be the shape of the “hole” or whether the “hole” edge is concave (indicating a protrusion) or not (indicating an actual hole in the surface).

In general, further feature characteristics also depend on the geometric model in question. In some embodiments, a further feature characteristic is a number of planar surfaces surrounding the footprint of the base feature characteristic on the plane. This feature characteristic and the foregoing base and/or further feature characteristics can be useful in the definition of connector pins in electronic models. These pins come in many different forms, including a footprint on a surface and a number of planar surfaces surrounding the footprint. For example, a single planar surface would indicate a circular cross section pin, at least at its base.

As mentioned previously, the separate unsuitable feature file allows separation of the definition of the unsuitable features from the code which carries out the method. The unsuitable feature file may also contain an indication of how the defined unsuitable features are to be modified. This can allow modification to be separate from the detection code.

Preferably, the unsuitable feature file is stored separately from such a computer program, which implements the detection (and optionally the modification) method. Advantageously the unsuitable feature file is also created and amended separately from this program.

The method may include modifying the unsuitable geometric feature to produce a modified model for analysis purposes.

Invention embodiments also provide a suitable environment for the user (or potentially the developer) to work with the unsuitable feature file. According to a further aspect, invention embodiments therefore provide a computer-implemented method of defining unsuitable geometric features of a CAD model comprising employing a graphical user interface on the computer to access an unsuitable feature file for holding definitions of geometric features which are unsuitable for analysis; employing the user interface to manually modify the unsuitable feature file to include a definition of a new geometric feature which is unsuitable for analysis (for example adding to or editing any definitions already present) and storing the modified unsuitable feature file in a database separately from any program implementing a method for detection and modification of the unsuitable geometric feature.

This aspect of the invention may be combined with the first aspect and with further aspects of the invention freely. As an example, the method may also be for geometric feature detection (and modification) and further comprise accessing a data file including a model of an object formed from basic geometric elements of the object, including lines, surfaces and at least one solid body element; detecting a defined unsuitable geometric feature included in the object, (possibly including the newly defined geometric feature) and optionally modifying the unsuitable geometric feature to produce a modified model for analysis purposes.

As in the first aspect, the new unsuitable geometric feature is added without access to software code for detection and modification of unsuitable geometric features.

According to a further aspect of the invention, which may be freely combined with the other aspects, invention embodiments provide a graphical user interface providing a computer-implemented method of defining unsuitable geometric features in a CAD model, wherein the interface is operable to access an unsuitable feature file for holding definitions of geometric features which are unsuitable for analysis, and to allow the user to manually update (modify) the unsuitable feature file to include a definition of a new geometric feature which is unsuitable for analysis (by adding to or editing definitions already present); and to display a representation of the defined unsuitable geometric feature.

A graphical user interface (GUI) is commonly provided as a computer software tool executed on a computing device such as a terminal which has at least a screen for display and input means for the user, such as a keyboard and mouse arrangement.

According to this aspect of the invention the GUI allows easy modification of the unsuitable feature file. Ease of use is enhanced if the hierarchy of feature characteristics as described as part of the first aspect is used in the unsuitable feature file.

Any suitable format can be used for a definition in the unsuitable feature file. For example the feature characteristics may be written as codes or script in text which may be executed in turn for automatic detection of features. Thus the manual modification may use text entry (of codes or functions) to select feature characteristics which are part of the new unsuitable geometric feature to be defined.

In modifying the unsuitable feature file, the user or developer can make use of pre-prepared functions. For example pre-prepared “mini-functions” may define for instance a right angle edge, check for a concave or a convex form or access any other simple geometric feature. Thus the GUI may allow access to a library of functions which can be called upon to define constituent parts of feature characteristics.

In a yet further aspect of the present invention, invention embodiments provide a computer-implemented method of geometric feature detection and modification comprising accessing a data file including a geometric model of an object, using definitions of geometric features which are unsuitable for analysis to automatically detect any defined unsuitable geometric feature included in the object; and modifying the unsuitable geometric feature to produce a modified model for analysis purposes wherein a shared hierarchy of feature characteristics is used for the definitions of at least two unsuitable features, at least a base feature characteristic in the hierarchy being present in the two unsuitable features.

According to this further aspect, a separate unsuitable feature file need no longer be provided (although of course this aspect can be combined with any or all of the other aspects set out herein). The shared hierarchy of feature characteristics as previously and variously set out is provided.

According to a still further aspect of the invention, invention embodiments provide a computer program which when executed on a computing device provides the graphical user interface of any of the preceding graphical user interface claims or carries out the method of any of the preceding method claims.

According to a last aspect of the present invention, invention embodiments provide a Computer Aided Engineering system comprising input functionality to read in a CAD file and/or unsuitable features file, output functionality to output a modified CAD file and or modified unsuitable features file, and computing capacity operable to carry out the method of any of the preceding claims.

The computer aided engineering system may comprise a single computing device or a network of linked devices having central or distributed computing resources, such as memory and processing capability. In the latter case the method and GUI functionality may be shared between users at different terminals. The input functionality may read in a CAD file and the output functionality may produce a CAD file of the same or a different format.

Features and sub-features of any of the aspects all form part of the same general invention concept and may be freely combined unless clearly incompatible.

Preferred features of the present invention will now be described, purely by way of example, with reference to the accompanying drawings, in which:—

FIG. 1 is a schematic diagram showing a simulation process chain and processing time;

FIG. 2 is a 3D representation of a geometric model and modification to provide a simplified model;

FIG. 3 is a 3D representation of a geometric model and modification to provide a simplified model;

FIG. 4 is a schematic diagram of basic geometric elements and their combination to form a body element;

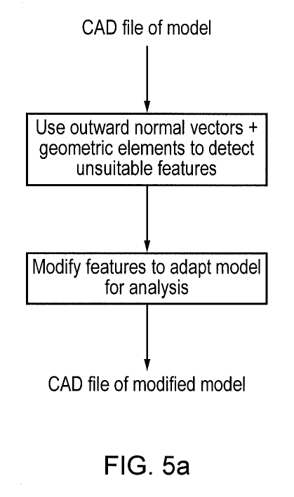

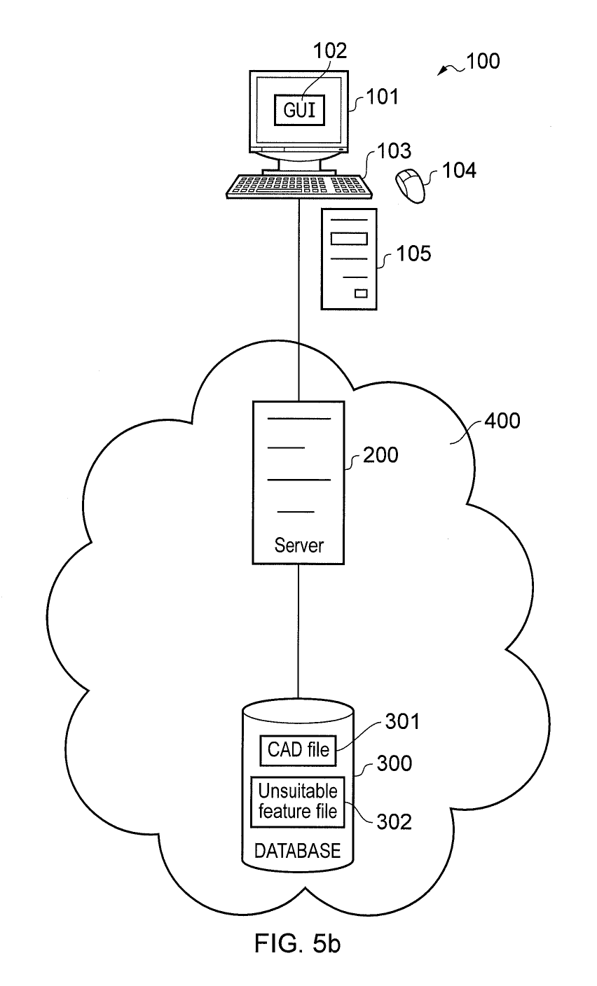

FIG. 5a is a flowchart of a general embodiment of the invention;

FIG. 5b is a schematic diagram of suitable hardware;

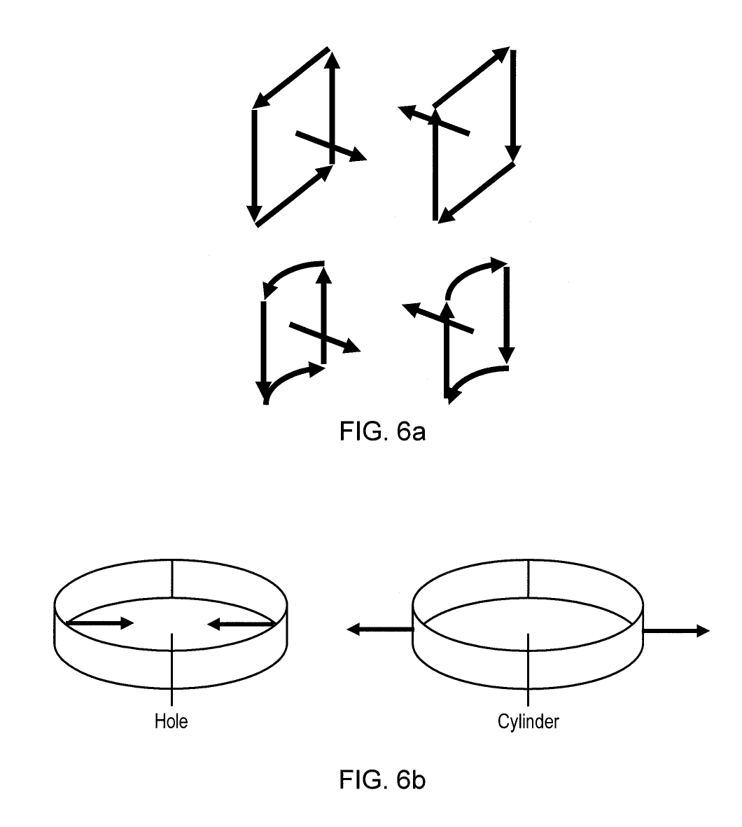

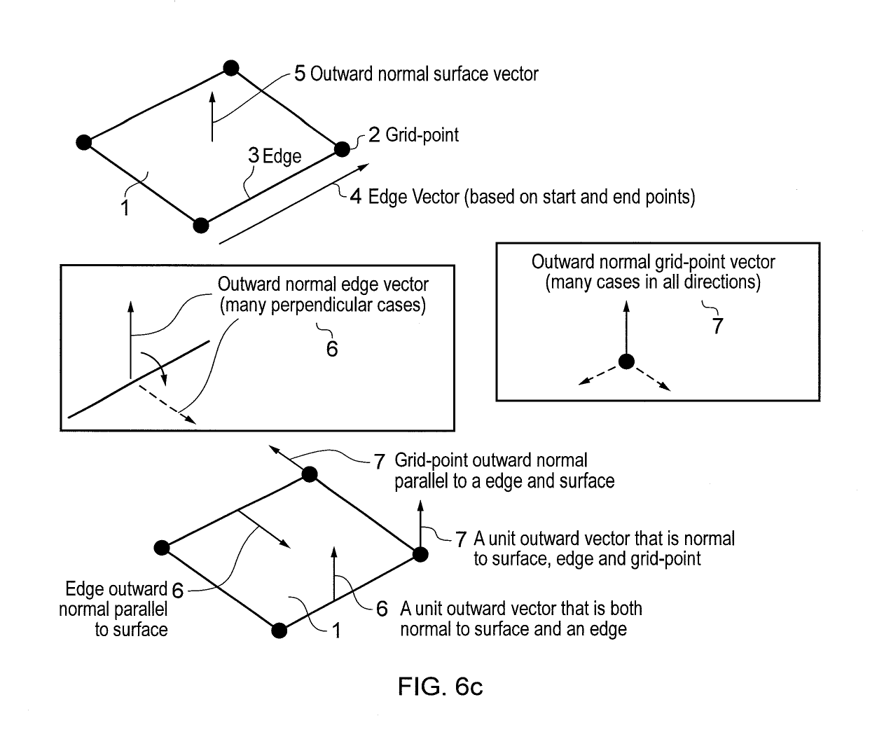

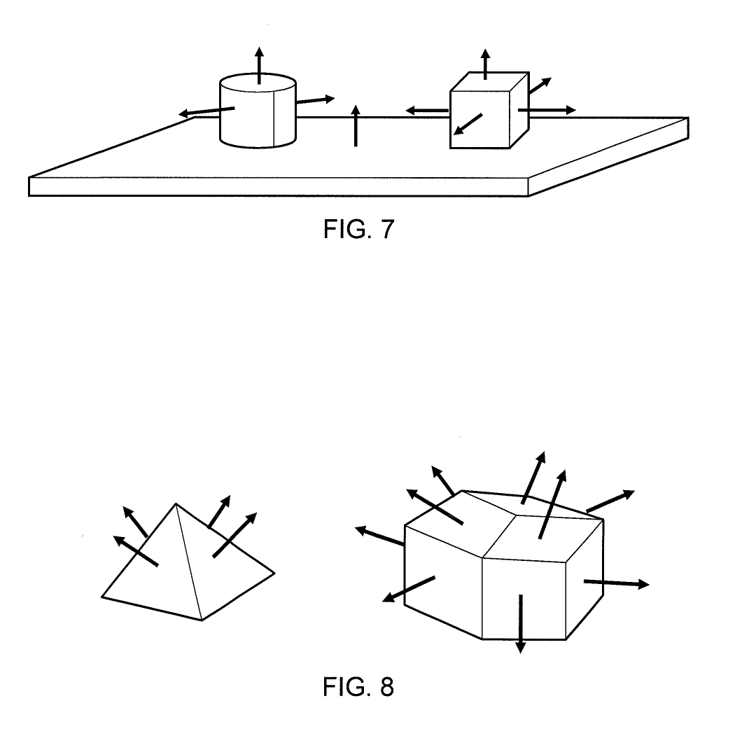

FIG. 6a shows planar and curved surfaces with line direction and outward normal vectors;

FIG. 6b shows outward normal vectors of surfaces in a hole and cylinder;

FIG. 6c shows edge vectors and point vectors, as well as outward normal vectors for surfaces;

FIG. 7 shows a cylinder and a cuboid tower feature with associated outward normal vectors;

FIG. 8 shows pyramid and arbitrary tower features with associated outward normal vectors;

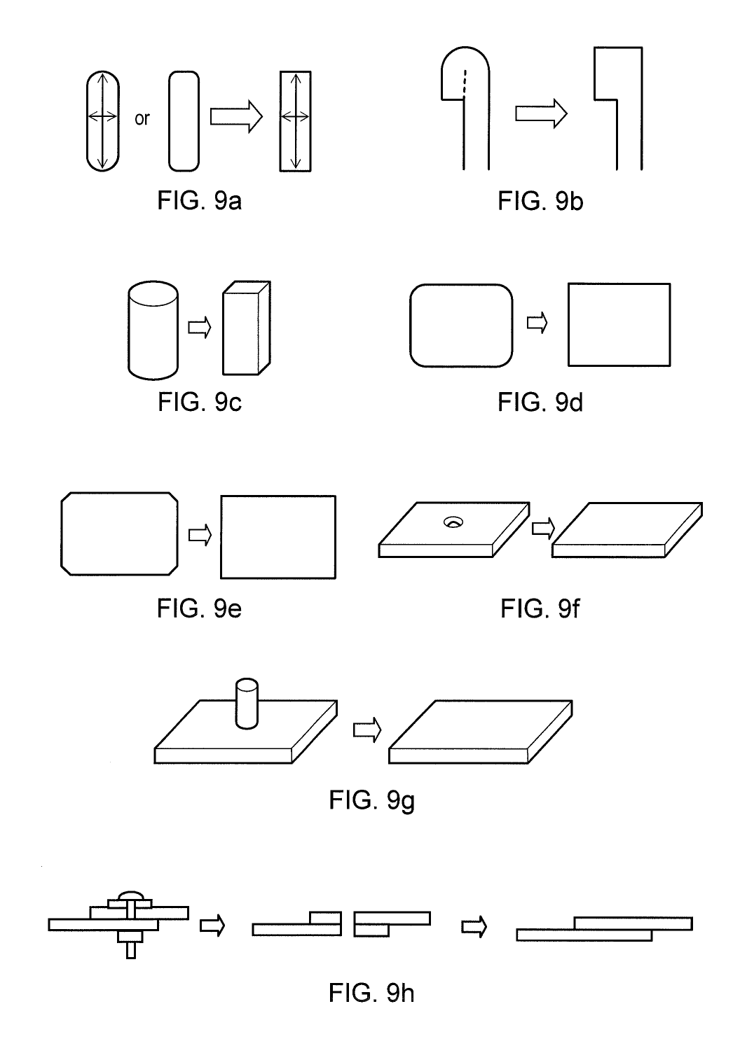

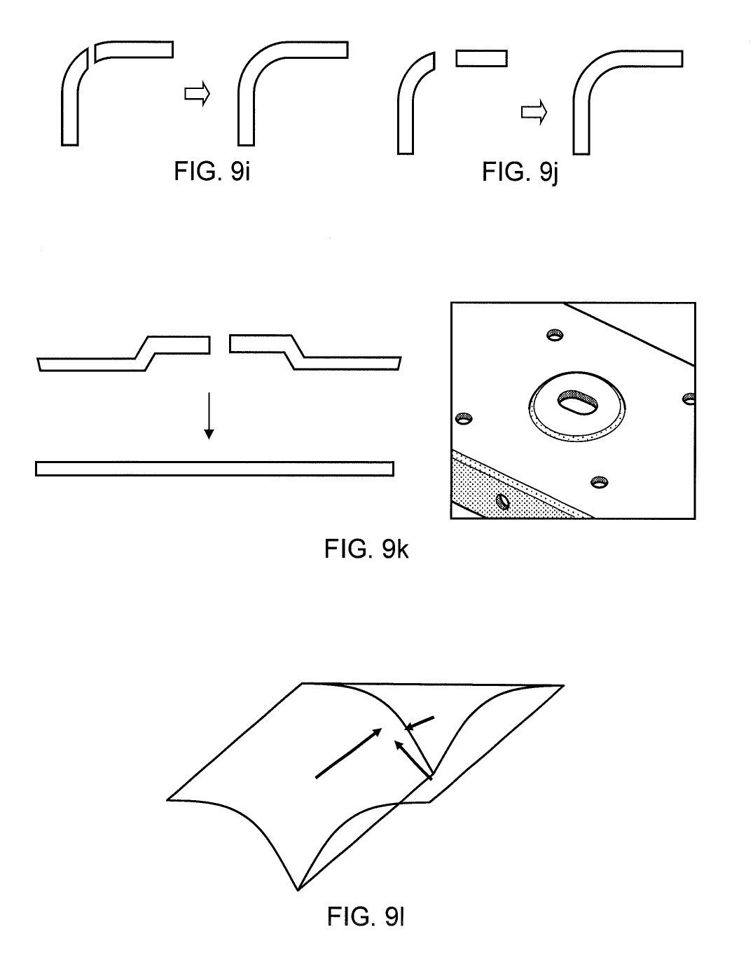

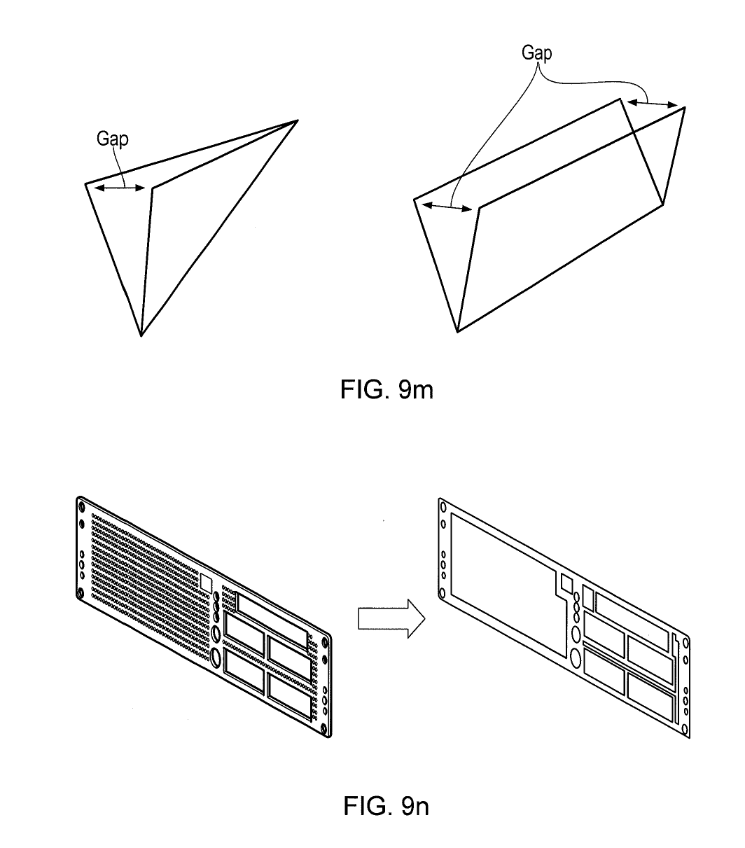

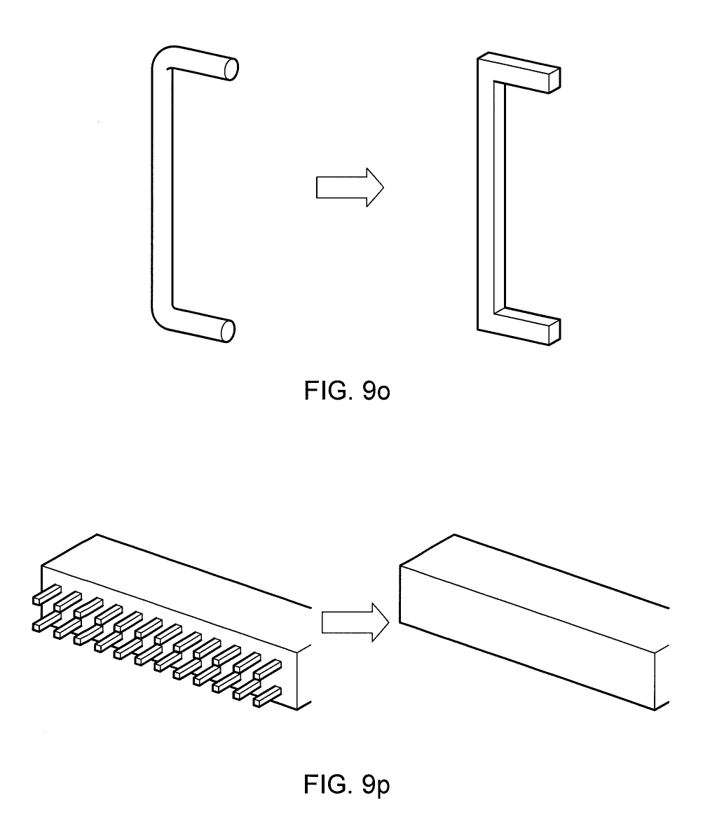

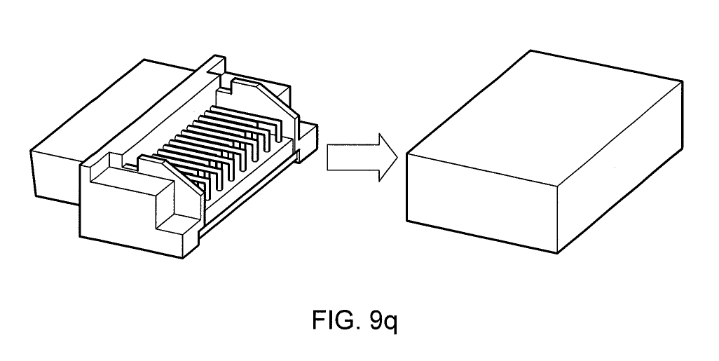

FIG. 9a shows modification of an oval or other curved cross-section or other curved cross-section part or hole;

FIG. 9b shows modification of a bend of sheet metal;

FIG. 9c shows modification of a cylindrical feature;

FIG. 9d shows modification of blends on a cross section;

FIG. 9e shows modification of chamfering on a cross section;

FIG. 9f shows removal of a small hole,

FIG. 9g shows removal of a small tower,

FIG. 9h shows removal of small parts, such as screws, washers and filling of the holes through which these parts pass;

FIG. 9i shows removal of a small hole on a blend;

FIG. 9j shows removal of a small hole on the boundary between a blend and a plane;

FIG. 9k shows removal of a hole and a small pressed feature;

FIG. 9l shows removal of a valley to form a flat surface;

FIG. 9m shows removal of a gap between two planes;

FIG. 9n shows removal of perforations in a sheet;

FIG. 9o shows modification of the cross section of a bent bar or pipe;

FIG. 9p shows removal of shaped pins;

FIG. 9q shows smoothing of a complex part using a bounding box;

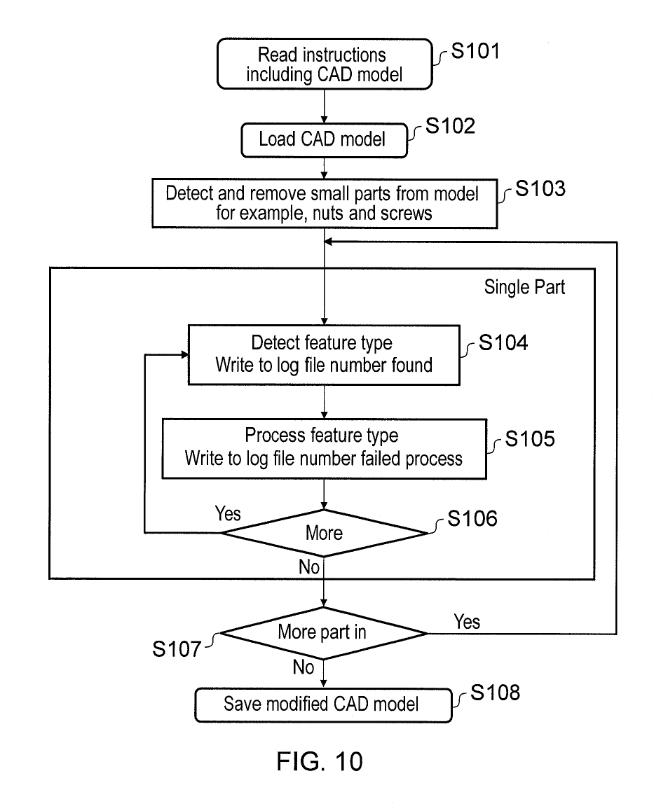

FIG. 10 shows a flowchart of automatic CAD model processing;

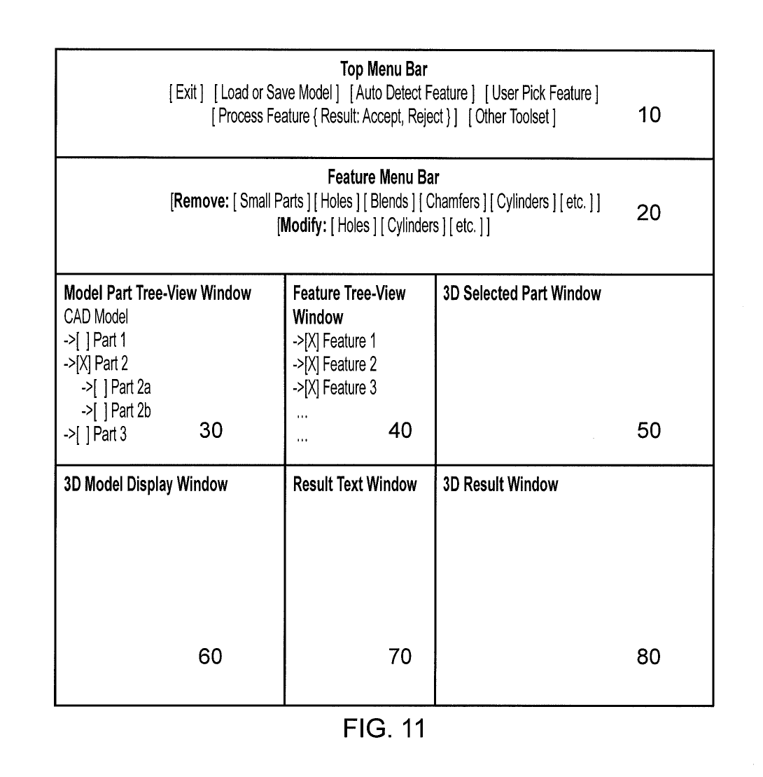

FIG. 11 shows an outline of the display GUI environment;

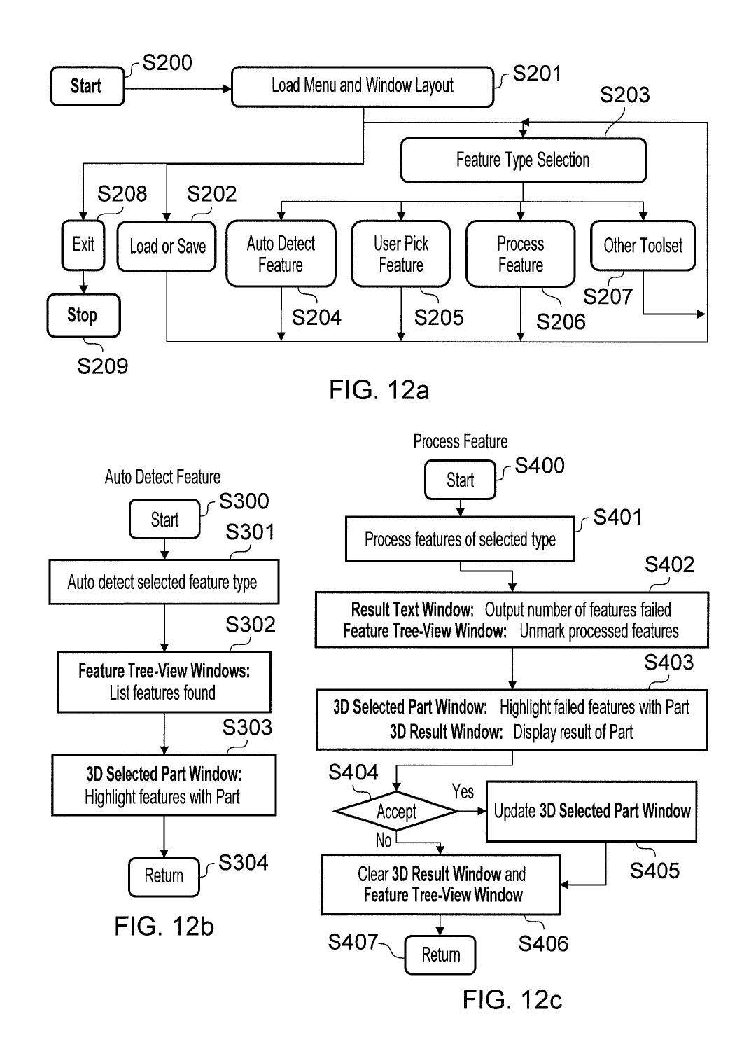

FIG. 12a shows a flowchart of basic GUI processing;

FIG. 12b shows a flowchart of GUI auto detector feature;

FIG. 12c shows a flowchart of GUI feature processing;

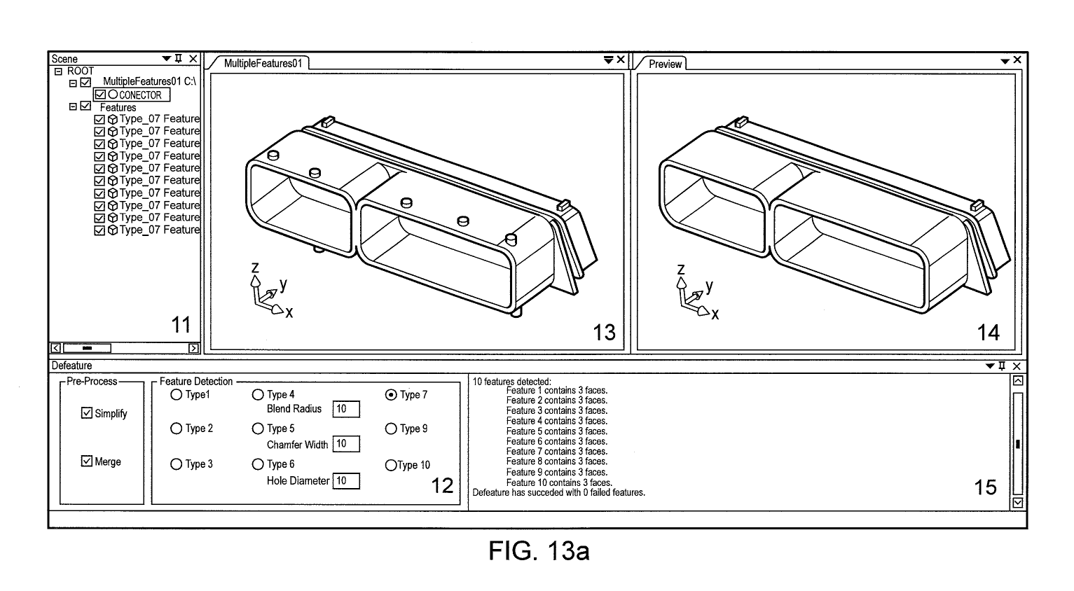

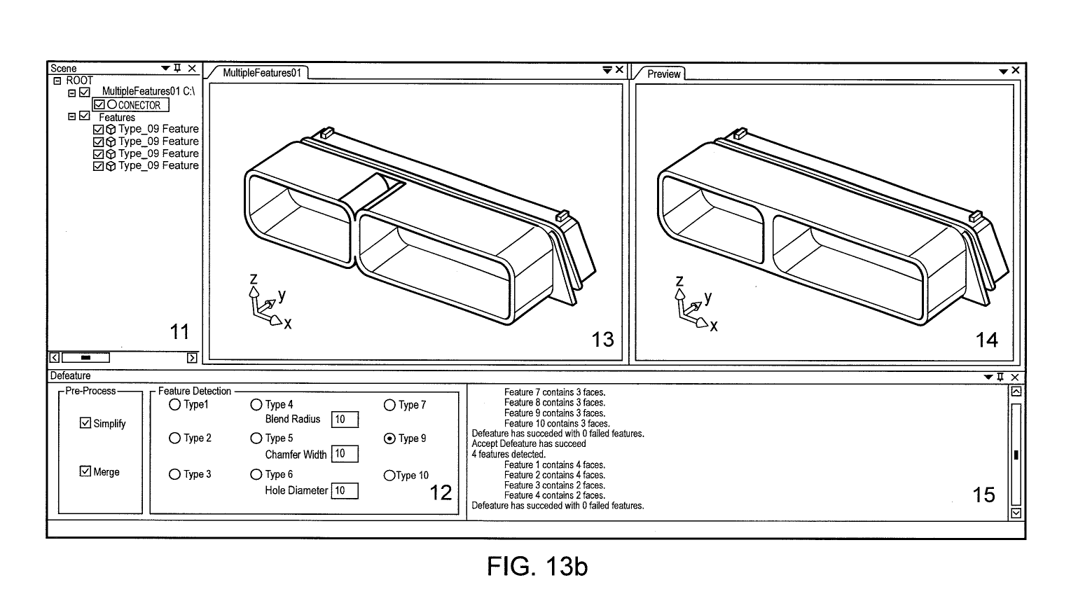

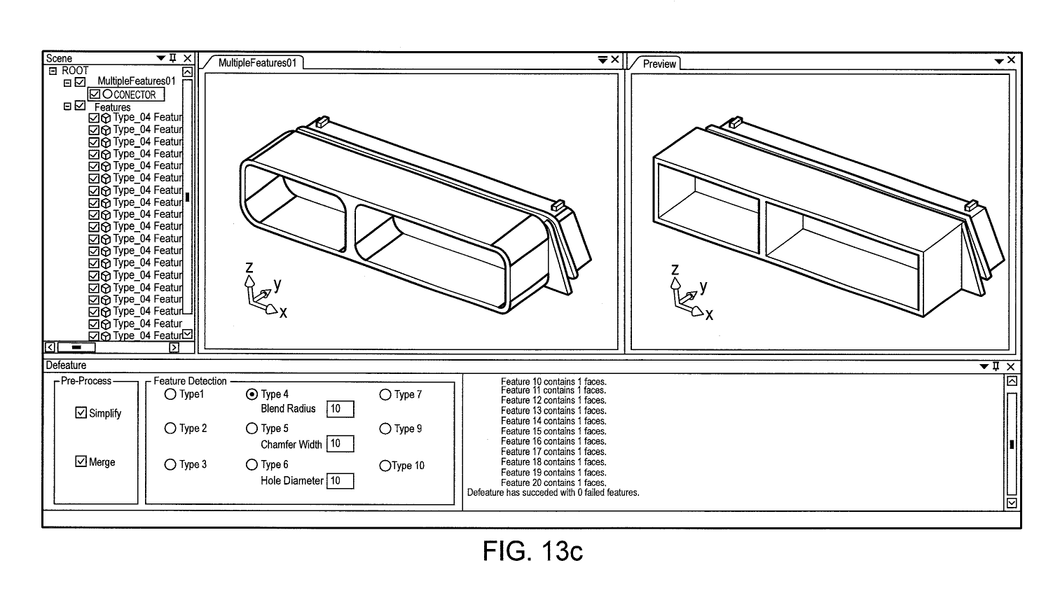

FIG. 13a shows a screen layout of a GUI demonstrating a first feature modification step;

FIG. 13b shows a screen layout of a GUI demonstrating a second feature modification step;

FIG. 13c shows a screen layout of a GUI demonstrating a third feature modification step;

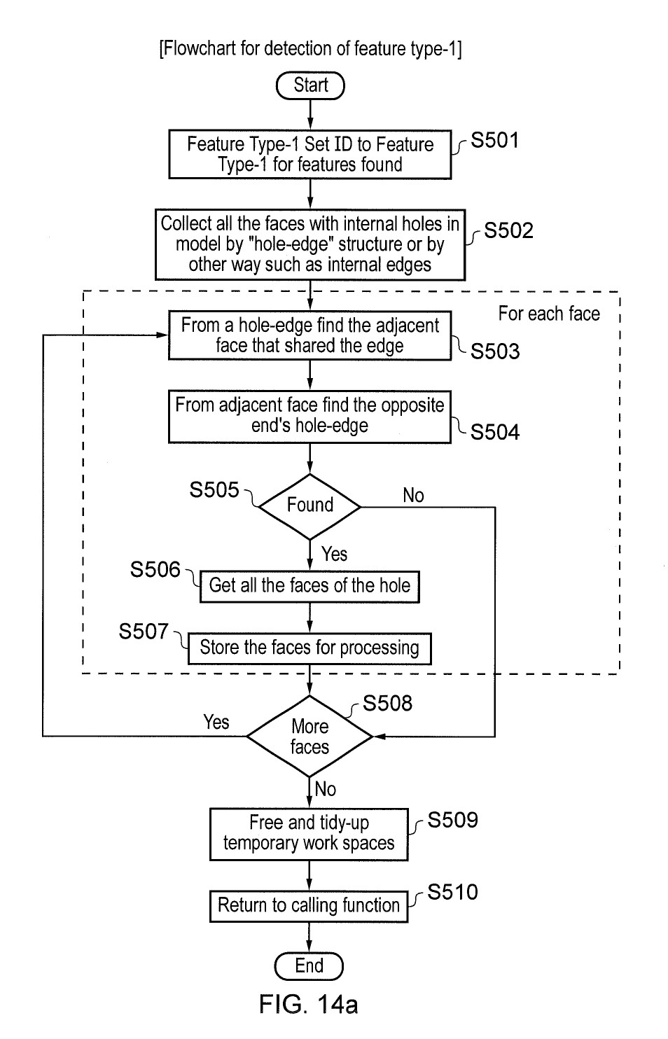

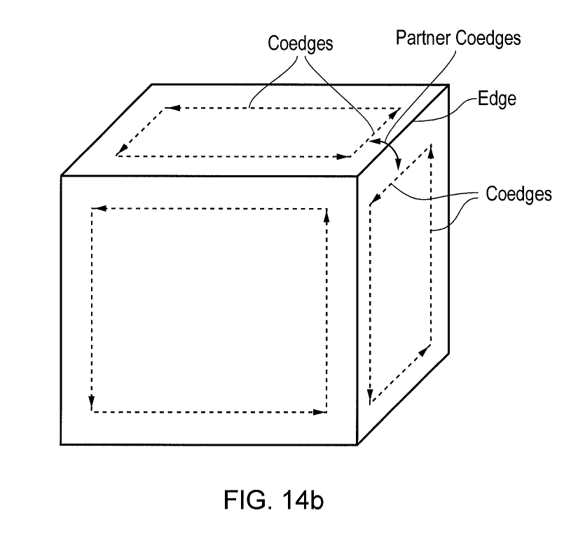

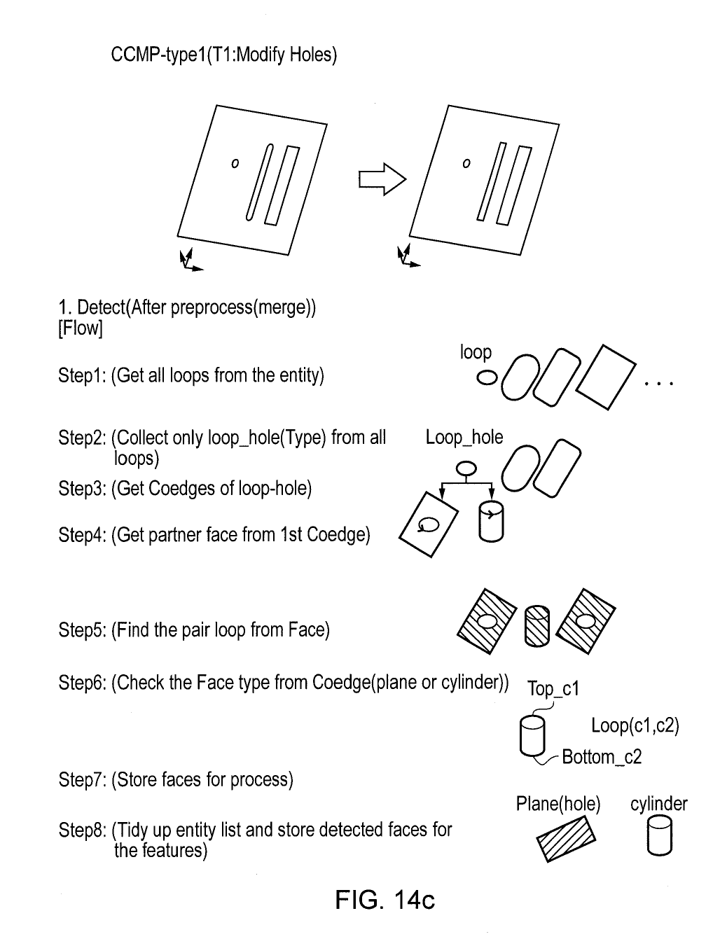

FIG. 14a shows a flowchart for detection of a hole feature type;

FIG. 14b illustrates the concept of co-edges;

FIG. 14c is an illustrated stepped sequence for detection of the feature type shown in FIG. 9a, using the concept of co-edges;

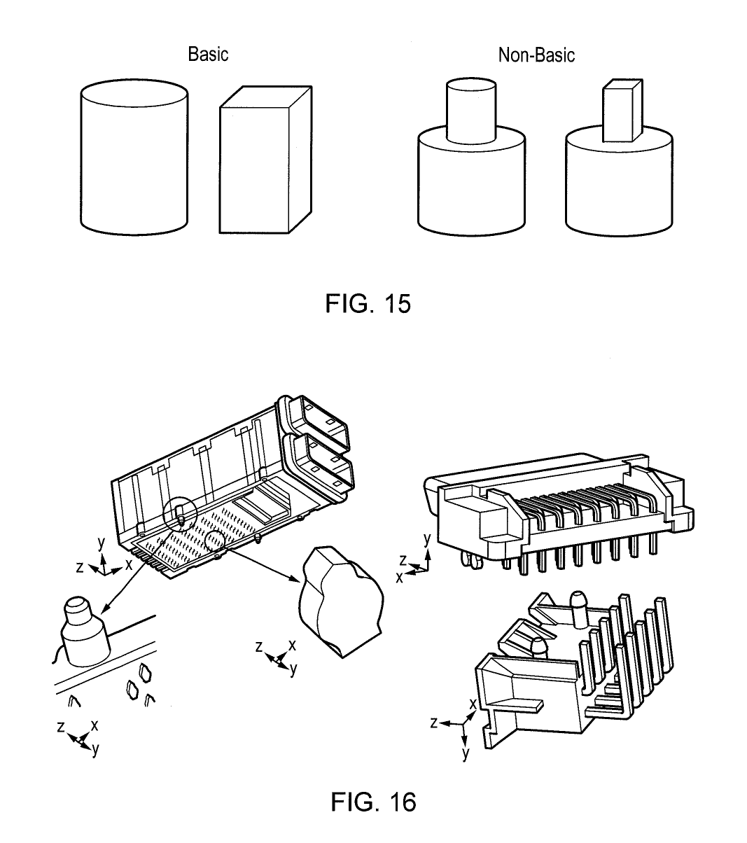

FIG. 15 shows basic and non-basic bumps;

FIG. 16 shows some examples of connector pins in electronic models;

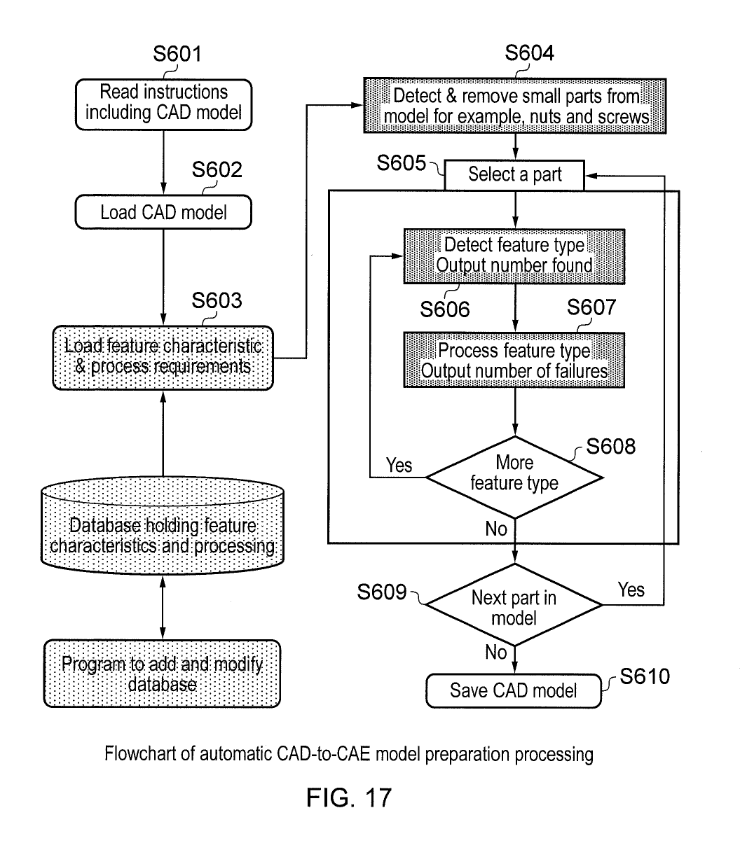

FIG. 17 shows a flowchart of automatic CCMP processing;

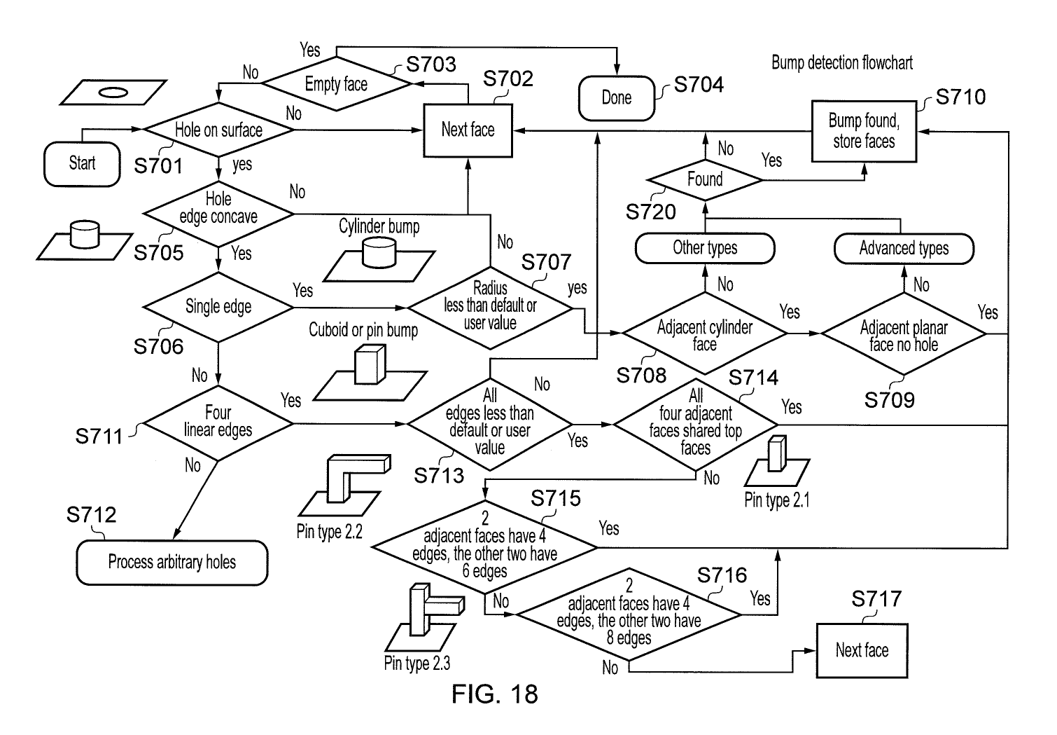

FIG. 18 shows a bump detection flowchart;

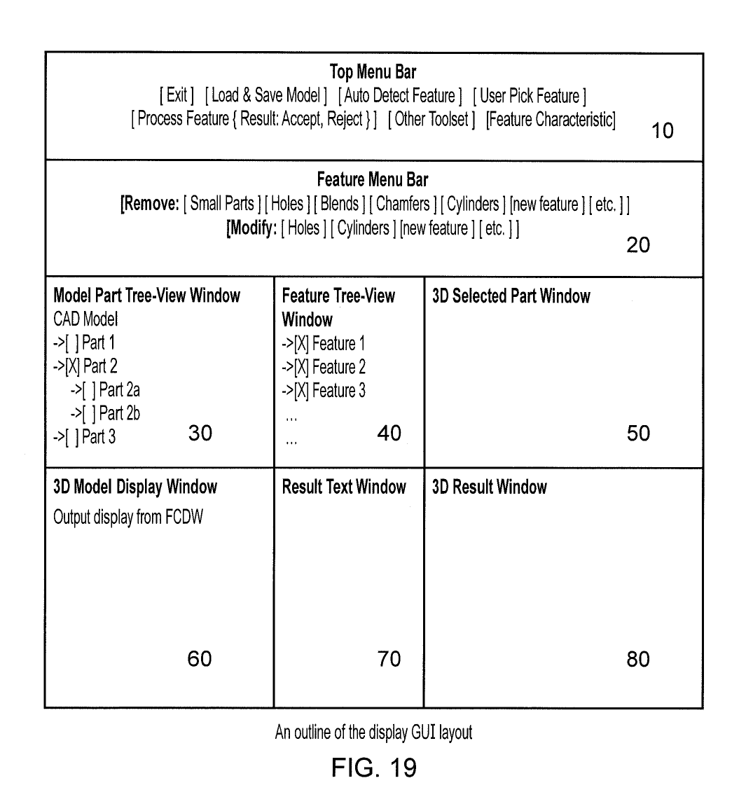

FIG. 19 shows an outline of GUI display layout; and

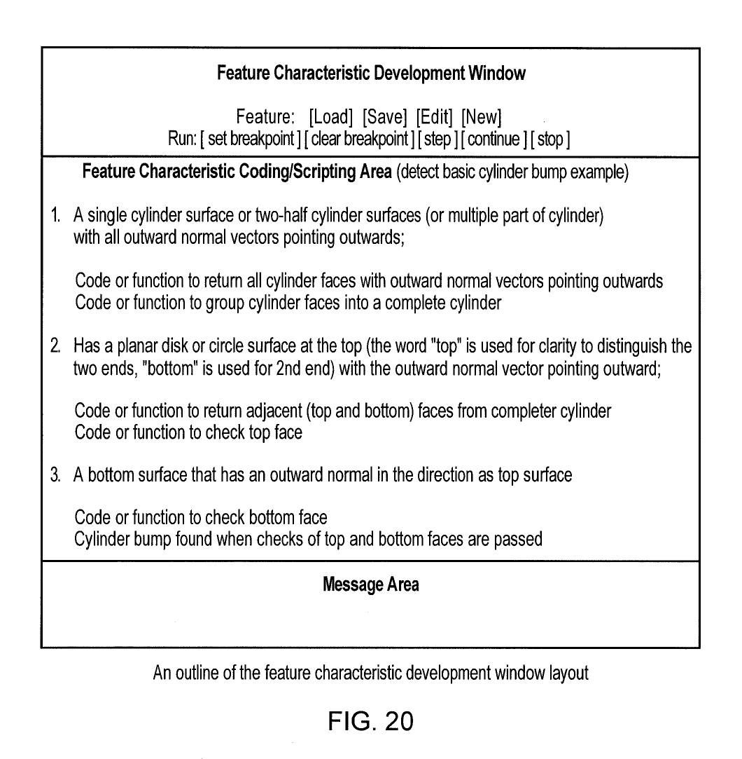

FIG. 20 shows an outline of a feature characteristic development window layout.

FIG. 5a shows a flowchart according to a generalised embodiment of the invention. Invention embodiments are preferably software implemented on a computer terminal (or PC) which has access to computing capacity to carry out a detection and modification method. FIG. 5b is a schematic diagram illustrating components of hardware that can be used with invention embodiments. In one scenario, the invention embodiments can be brought into effect on a simple stand-alone PC or terminal 100 shown in FIG. 5b. The terminal comprises a monitor 101, shown displaying a GUI 102, a keyboard 103, a mouse 104 and a tower 105 housing a CPU, RAM, one or more drives for removable media as well as other standard PC components which will be well known to the skilled person. Other hardware arrangements, such as laptops, iPads and tablet PCs in general could alternatively be provided. The software for carrying out the method of invention embodiments as well as a CAD data file and an unsuitable feature file (if required) may be downloaded, for example over a network such as the internet, or using removable media. A modified CAD file can be written onto removable media or downloaded over a network.

Alternatively, PC100 may act as a terminal and use one or more servers 200 to assist in carrying out the methods of invention embodiments. In this case, the CAD file 301 and/or unsuitable feature file 302 and/or software for carrying out the method of invention embodiments may be accessed from database 300 over a network and via server 200. The server 200 and/or database 300 may be provided as part of a cloud 400 of computing functionality accessed over a network to provide this functionality as a service. In this case, PC 100 may act as a dumb terminal for display, and user input and output only. Alternatively, some or all of the necessary software may be downloaded onto the local platform provided by tower 105 from the cloud for at least partial local execution of the method of invention embodiments.

Returning to the flowchart of FIG. 5a, initially a CAD file defining a model of a 3D object is read into the terminal. Then an unsuitable feature file is read into the terminal. The method detects the unsuitable features of the model which are included within the unsuitable feature file. For example, the geometric definitions in the CAD data file may be used together with calculated outward normal vectors to detect unsuitable features, as explained in more detail later. The features may be those that are deemed to be unsuitable for efficient analysis in a CAE simulation. In a further process one or more of these features is modified to make the model better suited for analysis. The outcome of the method can be viewed as a simplified CAD file, that is, a CAD file with an approximated version of the model which is better suited for analysis.

### Basic Methodology Using Outward Normal Vectors

Invention embodiments provide an automatic detection tool for detecting small features and/or other unsuitable features in CAD models. The tool requires basic geometric elements common to all CAD models, namely (vertex) points, lines and arcs, joining the vertexes to form surfaces and their connection as a body as shown in FIG. 4. The CAD model is a solid body or an assembly of solid bodies. Each solid body is a topology set connecting the entities of basic elements. Invention embodiments may use normal vectors in detecting unsuitable features and start from a particular methodology of approach according to a basic, related art arrangement. The basic methodology is set out in detail in the following sections.

The basic methodology uses just the CAD model file with its definition of basic geometric elements in conjunction with the vector properties of basic geometric elements to detect (and optionally modify) geometric features which are unsuitable for analysis. Such unsuitable features may be selected using predetermined criteria adapted for the analysis and/or simulation required by the design engineer. They are detectable because the combination of vector properties, such as the outward normal vector, and geometry relating to the feature together give a characteristic signature of the geometric feature concerned.

The unsuitable feature may then be modified to produce a modified model for analysis purposes. The modification may be included in a computer program for the detection method. Alternatively, the output from a detection program can be used by a different program for modification.

As the skilled reader will appreciate, the term “outward normal vector” for a surface refers to a vector perpendicular to that surface. On a closed surface, for example, the inward-pointing normal points toward the interior of the surface and the outward-normal vector points towards the exterior of the surface. In general the outward normal vector is used to indicate the side of the surface, edge or point that is on the outside of the solid body element. Any other properties of the vector are not important. Vectors can be used in vector operations (for example the dot product of two vectors) to explore the geometry of the model.

The data file may be any file which is used to define a 3D object in a computer environment and need not itself define outward normal vectors. Of course the data file may in fact also include outward normal vectors and other vector properties and information but the method of invention embodiments requires only basic geometric data. This is particularly advantageous because all the different formats used for storing CAD information must at the very least contain such information.

Unsuitable geometric features can be detected using vector properties and in particular using outward normal vectors of surface(s) and or edge(s) and/or point(s). Most implementations used outward normal vectors of surfaces.

FIG. 6a illustrates the direction of lines (edges) in a CAD model forming a surface. These are the edge vectors. The outward normal vectors for the surfaces formed are also shown,

For cylinders the two outward normal vectors for the half-cylindrical surfaces are pointing away from the centre, as shown in FIG. 6b. The outward normal vectors of the top and/or bottom surfaces (not shown) complete the cylinder. One defined top or bottom surface would make the cylinder a protrusion, and two would make it a separate solid body.

FIG. 6c shows a single surface 1 with some of its vector properties. The surface is formed of points, or grid points 2, joined by lines or edges 3. Each edge has an edge vector 4 along the edge. The surface itself has an outward normal vector 5. The edge has many possible outward normal vectors 6. The point also has many outward normal vectors 7. All these vectors may be normalised and for example aligned or perpendicular to the surface. The vector properties of the CAD model can be used together. For example, edge vectors can be used to detect the angle of two surfaces, or to check if an edge is concave or convex. Using vectors and vector operations in combination with basic entities such as edges, arcs, faces, etc., we can build many tools/functions to test, evaluate and find characteristics of unsuitable features. This in turn can build up the characteristic profile of the unsuitable feature to a high degree of confidence. Naturally, if higher accuracy is required the number of feature characteristics included in the profile will increase accordingly.

FIG. 7 shows the outward normal vectors for a cylinder and cuboid towers on a planar surface. FIG. 8 shows similar outward normal vectors for a pyramid and an arbitrary tower. For solid features that are attached to the main body (protrusions), the surfaces form a closed loop with all the outward normal vectors pointing away from the centre of the feature. Only the main body outward normal vector (belonging to the surface from which the solid features protrude) points into the feature.

In one example of the basic methodology, the detection of an unsuitable geometric feature includes calculation of an outward normal vector for a surface and for at least one neighbouring surface. Depending on the unsuitable geometric feature, the outward normal vector for three or more surfaces may be required.

As an exception, for a cylindrical hole as defined in some CAD packages, just one outward normal vector may be detected, allowing detection and modification of the hole. The outward normal vector is that of the full cylindrical surface defined in the CAD package. As an aside, CAD packages usually include the definition of nominal surfaces delimiting the hole, one delimiting the “top” of the hole and other delimiting the “bottom”, however the normal vectors from these nominal surfaces is not necessarily required to detect and modify such cylindrical holes.

In a different example, in order to detect an edge finish such as a chamfer, blend (radius) or other similar structure, the outward normal vectors of the edge finish itself and the outward normal vectors of the planar surfaces which intersect at the edge finish can be calculated. Initially, the small area surface of the edge finish may be detected (for example as a part of a cylindrical surface for a blend), and then its outward normal vector and the outward normal vectors of its (planar) neighbouring surfaces may be calculated.

Detecting an unsuitable geometric feature may thus include identification of a set of surfaces forming a discrete feature and calculation of outward normal vectors of that set of surfaces. The feature may be viewed as discrete and the surfaces as adjacent in that no surface of the feature is separated from all the other surfaces of the feature. The adjacent set of surfaces may be referred to as a closed loop of surfaces. The edge finishes mentioned above and their neighbouring surfaces form such a closed loop.

In another example, a through-hole or through-bore (referred to herein as a hole) may be defined in some CAD packages that do not support full cylinder definitions to include two half-cylindrical surfaces with outward normal vectors pointing inward. These two surfaces form a closed loop (as does the equivalent geometrical definition of a single cylindrical surface). If the definition of the hole includes two nominal surfaces, one delimiting the “top” of the hole and other delimiting the “bottom”, these represent surfaces which may also form part of the set of adjacent surfaces. Similarly, the surfaces of a cylinder defined with two half-cylindrical surfaces forming a closed loop have outward normal vectors pointing away from each other and a top and bottom surface each with an outward normal vector pointing away the other flat surface vector.

The skilled reader will appreciate that the geometric properties and outward normal vector(s) in each case together give a recognisable characteristic signature of the unsuitable geometric feature.

Once the unsuitable geometric feature has been detected using one or more outward normal vectors, the feature may be modified. The modification may be included in a computer program for the detection method. Alternatively, the output from a detection program can be used by a different program for modification. The type of adaptation applied to the feature is any which is suitable for making the model as a whole easier to analyse. In preferred embodiments the modification applied to the unsuitable feature may fall into one of two categories; reshaping or removal.

In many situations, small features can be removed to make the analysis of the model simpler without having a significant effect on the results of the analysis. Of course this depends on the model itself and type of analysis applied and will vary on a case-by-case basis.

Some larger features which cannot be removed without affecting the results of the analysis may be modified to make the calculation in analysis simpler. For example and particularly in finite difference methods, curved surfaces can make calculation in analysis much more time-and-resource-intensive. In this and other cases, features can be modified, for example to remove curves. For instance, a curved surface may be rendered as a plurality of flat surfaces which together give approximately the same configuration as the curved surface.

Turning in more detail to the geometric features which may be viewed as unsuitable, one unsuitable geometric feature is a cavity, hole (concave features), protrusion or solid body (convex features) of any shape but smaller than a predetermined size and a corresponding modification is removal of the small unsuitable geometric feature. This is the case in which smaller features can be removed. The size of the feature may be determined for example according to volume of the feature or other size parameter of the feature or of one or more individual surfaces making up the features. The computer system used by the designer may have a small feature volume parameter which can be set by the designer. Typical small unsuitable geometric features can be nuts, bolts and washers (solid bodies) which are present in the model in conjunction with other larger parts. These parts can also potentially be detected by part number in a CAD/CAE design package in which case the specific step of their detection does not fall within the scope of the invention. Other small geometric features may be small holes, small cavities (that is any shape of blind hole smaller then a certain size), and protrusions which form a projection on a larger surface. As the skilled reader will appreciate, all of these small geometric features are formed from a closed loop of surfaces as defined hereinbefore.

### Feature Processing Order According to the Basic Methodology

It can be determined if a feature is small or not by comparing to a specified parameter such as calculating the volume of the arbitrary shape and comparing to a small feature volume parameter value. This parameter can be set by the user or from experiment for particular kinds of model.

To locate small features, the process may start by calculating the area of surfaces and then order these in sequence of size. Naturally, the smallest surface area has a high chance that it is associated with a small feature. Checking there is a closed loop of surfaces with a characteristic signature as described previously, small features are detected. Repeating the process for the other surfaces, all small features can be detected.

Once any small features have been processed, other unsuitable geometric features can be detected.

For example, in detecting either a blend or chamfer, the software can search for a small surface which is either curved or flat and whose outward normal vector is at around 45 degrees to outward normal vectors of major surfaces on either side of it. A fold may detected as two quarter cylindrical surfaces and the corresponding neighbouring major surfaces sandwiching the quarter cylindrical surfaces.

All these edge finishes may be on external junctions or internal junctions. Thus, material may be removed to create them (on the external junctions) or added to create them (on internal junctions). The edge finishes may be at the intersection of two surfaces or at three or more surfaces.

The feature processing order is important to both processing speed and processing success. Basic feature types can be detected very efficiently using the detection method described in herein before. The process of removal or reshaping can also be implemented efficiently. Using these basic feature types in combination and more importantly in a preferred order of execution provides a very powerful tool to CAD model processing. Large and complicated models can be processed in this way. Naturally, adding extra feature types provides more ways to process more types of CAD models, either as new feature type or a combination set. A combination set uses existing predefined unsuitable geometric features (or feature types) to process complex features without actually creating a new type with a different characteristic signature, by simplifying the complex feature one feature element at a time.

### Types of Feature Processed

FIG. 9 shows a variety of features that can be modified for by reshaping or removal. The modification processing can be fully automated by processing one geometric feature at a time.

FIG. 9a shows the processing of an oval part or hole, or in more general terms a part or hole with a curved surfaces, so that there is a curved portion of its cross section, to form a cross section with straight edges, shown here as a rectangle. The software detects the closed loop of surfaces and curved surfaces to identify this type of unsuitable feature. As mentioned above, dependent on the kind of analysis required after the model has been modified, it might be necessary to conserve the volume and/or length of the part that is modified.

FIG. 9b indicates how a bend finish at the edge of a sheet of metal can be modified to provide a thicker portion with straight edges. Here a small half-cylindrical surface (perhaps formed from two small quarter-circles surfaces in pre-processing) can be detected, along with the angle to the surfaces on either side of it using normal vectors. For the modification the cylindrical surface is squared-off. The folded over portion is also considered as a single thicker portion of metal forming a border at the edge of the metal sheet.

In FIG. 9c a cylindrical feature is modified to form a square cross-section feature. The software detects a closed loop and curved surfaces of the closed loop. As before, we may need to consider the volume and or length of the feature.

In FIG. 9d blends are removed from a cross section using software to search for a right angle between two planes and cylindrical curves between the two planes.

In FIG. 9e chamfers are removed in a similar fashion.

In FIG. 9f a small hole (which might be an oval cross section hole or a slot etc) is removed by detection of the cylindrical/half-cylindrical surfaces and their normal vectors. Correspondingly in FIG. 9g a small tower is removed. This tower is treated in a similar manner to the cylindrical feature shown in FIG. 9c, by detection of a closed loop of surfaces, the only difference being that the bottom surface of the protrusion is not defined.

FIG. 9h shows a combination set of parts for modification. Firstly, small parts are removed and then the holes into which the small parts fitted are removed, as described for FIG. 9f.

In FIG. 9i a combination set of a small hole on a blend is removed whereas FIG. 9j shows a hole in the boundary between a blend and a plane being removed. Here the notional end surfaces (top and bottom surfaces) of the hole are at an angle to each other and to the cylindrical surface. Previously may not have been possible to automatically detect such holes, but the basic methodology can detect and remove them. FIG. 9k shows a pressed feature with a blend and a hole within the pressed feature being removed. The normal order of modification would be to first remove the blend applied to the edge of the pressed cavity. Then the through-hole is detected and removed. Next a different feature type is used to identify the pressed cavity, with its top and bottom surfaces having an adjoining surface on the outer edge that is non-planar and circular based (here frusto-conical). Alternatively, the pressed cavity and through-hole can be removed together as a single process.

FIG. 9l shows a small valley which is removed to form a flat surface. The software identifies the valley as an irregular blend.

FIG. 9m shows a body with a folded-back portion. There is a gap between two sides of a folded sheet. The detection software picks up this gap (which could alternatively have been remedied in an earlier merge step) and modification joins the two parts of the face together to close the gap.

FIG. 9n shows rows of perforations which are detected and modified together to form a non-perforated sheet. The detected holes need to be grouped together and of the same type and size. The group of holes is then processed as a single entity that is removed and replaced by a new separate part with no holes (shown in darker shading on the figure) and porosity information corresponding to the holes. The porosity information can for example allow the modified model to retain the same airflow through the part concerned. The original part is effectively modified with a “hole” filled in by the new part with the higher porosity.

FIG. 9o shows a cylindrical cross-section bar or pipe bent in the shape of a handle. Modification changes the cross-section to a rectangular one.

FIG. 9p shows rows of rectangular cross-section pins, which are removed to simplify the model. The pins are detected in the normal way as bump/pin feature types. Similarly to the perforated case, the group of pins of the same type and can be modified together. This type of arrangement is likely to be a connector. After removal of the pins, a bounding box can be used to further simplify the shape, as shown below in FIG. 9q.

Finally, for the purposes of comparison, FIG. 9q shows a different technique, in which a bounding box is created manually to smooth the contours of a complex part. The part may be identified by part number or selected by the user: there is no automatic detection.

### Codifying the Sequence for the Basic Methodology

The CAD model processing tool of the basic methodology can be made to process CAD models automatically with given instructions or scripts of the processing sequence of feature types so that the order of execution is pre-set. For example, automatic model processing of removing holes, blends and cylinder towers can use an equivalent to the following pseudo-code instructions. To process all feature types, the instruction can be “Process-Feature-Type: All”.

$$Load \text{-} File \text{:} CAD\_Model \cdot stp$$

$$Process \text{-} Feature \text{-} Type \text{:} Hole$$

$$Process \text{-} Feature \text{-} Type \text{:} Blend$$

$$Process \text{-} Feature \text{-} Type \text{:} Cylinder \text{-} Tower$$

$$…$$

$$Save \text{-} File \text{:} Modified\_CAD \_Model \cdot stp$$

After a feature type has been processed the following information may be written to a log file.
1. Number of features found.
2. Number of features failed in the modification process (optionally with feature identification).

On completion of a process, the result may be saved to either the original CAD model format or to a different CAD model format from the input instruction.

FIG. 10 is a flowchart of automatic CAD model processing according to the basic methodology.

Instructions such as parameters are read with the CAD model in step S101. In step S102 the CAD model is loaded. In step S103 before the main loop, small parts are detected and removed. The main loop is performed for each single part (or solid body element). For each part a feature type is detected and the number of this type of feature found written to a log. The detected/features are then processed. Any failed features are also written to a log. It is determined if there are more feature types remaining for processing in step S106 and if so the next feature type is processed. The feature types may be processed in a predetermined order, for example in the order defined by the pseudo-code set out hereinbefore. Once there are no more feature types to process, the processing is finished for that part. Next it is detected in step S107 if there are more parts and if so a next part is selected and the main loop repeats. Once all the parts have been processed the modified CAD model is saved in S108.

In cases where features failed in the modification process, the graphical user interface part (see next section) can provide a valuable tool to help users, first to see the failed features (by running feature detection), then to help remedy the problem.

### Graphical User Interface of the Basic Methodology

Some objects of the GUI tool are to:
1. Provide users with a graphical environment with processing tools for CAD model processing—with the automatic feature detection and modification technologies described above for the automatic CAD model processing (AMP).
2. To view the features failed in the modification process of AMP tool (perhaps first to run feature detection to show these features) and then help users towards a remedy with toolset functions in the GUI.
3. To develop new combination feature sets for efficient automatic processing in the AMP tool. This is every valuable for new feature types and new CAE applications.
4. To give the ability to view and share models between users at different locations via a network/communication medium.

The GUI aspect provides a graphical environment with 3-dimensional display of CAD models. User input functionality may be provided conventionally, with for example a mouse and a keyboard. FIG. 11 provides an outline of an on-screen display environment, and FIG. 12 is the flowchart of the GUI CAD model processing.

FIG. 11 shows an outline view of a GUI front end of the basic arrangement. A top menu bar 10 provides basic features of exit, load and save model, auto detection, user pick feature, feature processing with the results of accept or reject and any other suitable tools. A feature menu bar 20 below the top menu bar gives selected capabilities of removing small parts, holes, blends, chamfers, cylinders and other parts or modifying for example holes and cylinders as well as other parts.

In the screen portion below the feature menu bar the screen is divided into three; a model part tree-view window 30 indicating which part of a model is being processed, a feature tree-view window 40 showing the features being processed and a 3D selected part window 50 highlighting detected features. In the lowermost portion of the screen there is also a division into three windows, a 3D model display window 60 which shows an representation of the model, a result text window 70 which gives the result of a process in text form, for example listing features detected and a defeaturing (modification) result. Finally a 3D result window shows the part as modified by the process.

FIG. 12a shows an overall logical flow of functions within a GUI according to invention embodiments. The process starts at step S200 and in step S201 the menu and window layout is loaded. At step S202 a model is loaded or saved. Once the model has been loaded and saved into the system the process can continue with a feature type selection S203. For example, the feature selected may be a hole of under a certain diameter. In step S204 such features may be detected. In step S205 the user can manually pick the feature. In step S206 the feature is processed. Step S207 provides any other relevant functionality. At any point after one of these steps, a new model can be loaded or the current model saved and the process can exit in step S208.

FIG. 12b is a more detailed flow chart of the auto detect feature of step S204 on FIG. 12b. The process starts at S300 and auto detects a selected feature type in step S301. In the next step S302, the features found are listed in the feature tree-view window shown in FIG. 11a. In step S303 the features are highlighted on the part which is currently undergoing processing in the 3D selected part window.

FIG. 12c is a more detailed explanation of the process feature step shown as S206 in FIG. 12a. The processing starts at S400 and processes features of the selected type in S401. In S402 the result text window outputs a number of features failed and the feature tree-view window unmarks processed features. In step S403 the 3D selected part window highlights failed features on the part and the 3D result window displays the results of the processing. If the result is accepted by the user in step S404 then the 3D selected part window is updated, if not the 3D result window is cleared and the feature tree-view window is cleared. Equally after updating the 3D selected part window these two windows are cleared. The process returns to the main loop in S407.

Of course this is only one configuration of the GUI environment. FIG. 13 is a view of a slightly different environment in which the top menu bar and feature menu bar are not show. FIG. 13a has a model part tree-view window 11 which shows that a connector model is being processed. The same window shows all the features currently detected by the process. In this case, small cylinders have been detected and this is denoted by type 7 in the defeaturing window 12. The defeaturing window also indicates that pre-processing has been selected, for example to remove small solid body parts such as screws and to merge curved surfaces which have been separately defined. The model is shown with the selected parts highlighted in window 13 which can be viewed as a 3D selected part window. Window 14 is a 3D result window containing a 3D representation of the defeatured part in preview (that is before acceptance by the user). Finally, window 15 is a result text window. The numbered features, of which 7 are visible in the view given each have three faces. These are cylinder protrusions on the main body which are geometrically defined to consist of two half cylinder surfaces with oppositely directed output normal vectors pointing away from the cylinder protrusion and a top surface. In the 3D result window, these protrusions have been removed. FIG. 13b has the same layout and shows the next step of the process in which features of type 9 (irregular blends) are currently selected. This feature corresponds for example to the valley of FIG. 91. The valleys at the top and bottom of the part are detected and removed.

In FIG. 13c the regular blends are removed. These are feature type 4, and a maximum blend radius has been selected for blend detection. The blends have been removed as shown in the preview in the 3D result window. The resultant simplified model is better adapted for analysis.

### A Detailed Example of Detecting Through-Holes According to the Basic Methodology

FIG. 14a is an example of a flowchart for detecting through-holes (denoted here as feature type-1). Such holes are modified by changing to rectangular through-holes aligned with the axis. If separate detection of holes with curved faces is required, so that the curved faces can be replaces with corresponding straight faces, then this can be done during the detection process (for example after step S506 below) or at the modification stage. Naturally, when all the faces are planar and aligned with the axis then there is no need to store faces for processing.

In step S501, the ID for the features located is set. In step S502, the software identifies all the faces in the model (or part thereof under consideration) which have internal holes. For each face, starting at step S503, the adjacent face to the hole on the other side of the hole edge is found (S503) and from the adjacent face, the opposite end of the hole is found (S504). If the opposite end is found (step S505), then the loop continues in steps S506 and S507 before step S508, and all the faces in the hole are collected and stored for processing, before it is determined whether there are more faces. If no opposite end is found, then steps S507 and S508 are omitted and it is immediately determined whether there are more faces in step S508. The loop in steps S503 to S507 continues until there are no more faces for processing. At this point, the workspaces used are tidied and released in step S509 and there is a return to the calling function in step S510.

To see how such a methodology might work with a certain CAD library, the concept of coedges is first explained in FIG. 14b. Coedges are defined in some CAD packages. A coedge is analogous to an edge, but solely owned by one face. Thus each edge of a model comprises two identically positioned coedges, one belonging to each face, as shown by the dotted lines (which are spaced from the actually edges for clarity). Each coedge has a direction associated with it to aid in traversing in the model. Thus the edge shown in bold in the figure is made up of two partner coedges having opposite directions, one coedge belonging to the top face, with a direction pointing into the page, and one coedge belonging to the right hand face, with a direction pointing out of the page.

FIG. 14c demonstrates the use of coedges in detecting for detecting holes with curved surfaces (denoted here as CCMP-type1 (T1:Modify Holes)).

The schematic at the top of the figure shows the modification applied to the holes once they have been detected. The schematics to the right hand side of the steps illustrate the geometry which is detected by each step.

In the detection process (after merge), all closed loops of surfaces are identified in Step 1. In Step 2 only the loops which form a hole in a surface are collected. In Step 3 the coedges are retrieved. This allows the adjacent surface (partner face) belonging to the partner coedge to be found in Step 4. From the partner face, the opposite end of the hole (pair loop) may be found in Step 5 and the face type (plane or cylinder) determined in Step 6. Step 7 stores the faces for processing and Step 8 tidies the entity list and stores detected faces.

### SUMMARY OF THE BASIC METHODOLOGY

In summary, the basic methodology requires a CAD model file only and no CAD systems. They can use basic geometric elements of lines, arcs, surfaces, bodies and usually also vertex points, and their inherent topology connections. Calculating the outward normal vectors of surfaces that form a closed loop can identify whether a small feature is a solid-, protrusion-, hole- or cavity-type unsuitable feature. Invention embodiments can automatically detect these types of features quickly by calculating the area of surfaces and orders in sequence of size, and starting with the smallest surface area, going through the surface topology to find a closed loop. For such closed-loop features we can calculate the volume to check if they are small enough for removal. Otherwise, a different modification process may be applied.

The basic methodology also provides a fully automatic (“batch-processing”) software tool for processing CAD models that includes the detection technology as set out hereinbefore.

The basic methodology also relates to a GUI software that provide the full functions of such an automatic software loop inside a graphical environment, together with further functions, for example for:
a. Visual inspection of CAD model;
b. Development of feature type combination set;
c. Helping to remedy failed features in the automated tool;
d. Sharing of view model with users at different location via communication medium.

### Specific Invention Embodiments

Specific invention embodiments build on the basic methodology to provide additional functionality by use of a hierarchical definition of the unsuitable features, referred to as “detection by characteristics” so that general geometric features can be addressed and new model features added. Additional or alternatively, invention embodiments allow the user to add new unsuitable features, for example using a separate unsuitable feature file and/or allowing modification without access to the source code for automatic detection and modification. Invention embodiments also develop the previously described GUI to incorporate additional functions.

### Detection by Characteristics

Using the basic methodology and use of outward normal vectors for automatic detection, the method is extended to address general geometric features and the ability to cover any CAD model features. The basic methodology now acts as a toolset for the new method of “detection by characteristics” (DBC).

FIG. 15 shows basic cylinder and cuboid bump/tower features, along with non-basic equivalents which have an extra protrusion from their top surface with the same cross-sectional shape as the lower part. DBC can be seen as an ordered list of feature characteristics starting with a base feature characteristic. The same DBC can be used to detect the basic feature and the non-basic feature.

For example to detect cylinder bumps, the construction of the initial DBC can be as follow. The first few feature characteristics of a cylinder bump can be described by three distinguishing elements.
1 A single cylinder surface or two-half cylinder surfaces (or multiple part of cylinder) with all outward normal vectors pointing outwards;
2 A planar disk or circle surface at the top (the ward “top” is used for clarity to distinguish the two ends, “bottom” is used for 2nd end) with the outward normal vector pointing outward;
3 A bottom surface that has an outward normal in the same direction as the top surface.

Then for each distinguishing element of feature characteristics we use the basic methodology using surfaces and calculating each surface's outward normal vector to check a CAD model to see if each condition is satisfied. If all three conditions are satisfied then the feature in question is a cylinder bump. For simple features like the basic cylinder bump, these three distinguishing elements are sufficient.

Similarly, the basic characteristic of a cuboid bump can be described by three distinguishing elements.
1. Four rectangle surfaces with all outward normal vectors pointing outwards;
2 A rectangle/square planar surface at the top with the outward normal vector pointing outward;
3 A bottom surface that has an outward normal in the same direction as the top surface.

For slightly intricate (non-basic) bumps such as those shown to the right in FIG. 15 the DBC is extended to include these bumps by adding extra distinguishing elements.

The characteristic for the non-basic cylinder can be included as below (cylinder case) with three extra distinguishing elements.
1 A single cylinder surface or two-half cylinder surfaces (or multiple part of cylinder) with all outward normal vectors pointing outwards;
2 A planar disk or circle surface at the top (the ward “top” is used for clarity to distinguish the two ends, “bottom” is used for 2nd end) with the outward normal vector pointing outward;
3 A bottom surface that has an outward normal in the direction as top surface;
4. If bottom surface is a disk surface then a middle surface has been identified, otherwise a basic cylinder bump has been found and process stop;
5. Below middle disk surface is a cylinder with outward normal vector pointing outward;
6. The bottom surface has an outward normal in the same direction as the top surface.

With the DBC approach, by adding more distinguishing elements to describe the characteristic of a feature, intricate features can be described straightforwardly.

Naturally, the detection accuracy of a very intricate feature cannot be 100 percent, in some situations there will be errors, but the advantage of this invention embodiment is that it can be amended or expanded easily by revising the feature characteristics to describe the unsuitable features in more details, thus adding to the number of unsuitable features covered in the DBC.

For example, in electronic models, connector pins are common features and they come in different variations as highlighted in FIG. 16. Expanding existing methods and technologies to cover all the variations is limited and even impossible when the particular variations have not yet been considered. Geometric feature variation is endless and no method can cover it all. With the DBC method it is possible to revise the characteristic as and when new feature variations are encountered.

The DBC approach can also be represented in overview as a hierarchical simple list of feature characteristics (without any detail as to how the feature characteristics may be identified). The partial listing below includes different varieties of protrusions from a surface (a bump)

```
Listing for Bump
1-Bump
1.1-cylinder
1.2-cuboid
1.3-pin (more complex than a cuboid)
  1.3.1 straight pin
  1.3.2 bent pin
  1.3.3 pin with fork
  .........
.............
```

### Users' Ability to Add New Features

Using the detection by characteristics method proposed in the above section, it is possible to develop the mechanism and software functions for users and developers alike to add new features and revise existing ones by themselves without access to source code. The data required for automatic feature detection and processing can be a simple data file read into the program at runtime. The same feature can be processed in different ways, for example a bump can be modified by changing its shape or removing it. Therefore the required processing is advantageously also included in the data file.

The instructions for detection and modification can be in the form of functions/codes for the feature types. Taking a hole as an example, and depending on the feature type, the instructions can first define the hole and then the modification, such as change of shape (FIG. 9a) or removal (FIG. 90. The function codes may be similar to a history file available in some CAD systems in which commands can be played back to recreate the model. The functions/codes are read and execute the internal functions in turn for automatic detection and processing of features.

Naturally, using advanced parser and/or other modern technology, the unsuitable feature file for input can be close to English language format and readable by users. The skilled person will be aware of the relevant parser technology. The thrust of these invention embodiments is in implementing the DBC method to offer new features which can be included in software at runtime for detection and processing. The major benefit to users and developers is that more features can be developed by more people and shared between them, shortening the existing approach in which only the developers or users with access to source code can add new features.

FIG. 17 shows the flowchart of the automatic CAD-to-CAE model preparation processing. The paler shaded boxes indicate the new elements needed to enhance the system in use for the basic methodology;

1) loading the feature characteristics data to use in the system;
2) database to store the feature data; and
3) a program to access the database to add, remove and modify features.

The darker shaded boxes are existing software components that need to be adapted to use the new data for automatic detection and processing.

In steps S601 and S602, the instructions are read, and the CAD model loaded. In step S603, the feature characteristics and process requirements for modification are loaded. In step S604, small parts are detected and removed from the entire model. In step S605 the loop for a single part of the model is started. In this loop, a type of feature is detected in step S606, and the number found outputted. The feature type is processed (modified) and the number of failures outputted in step S607. In step S608 the loop is repeated for a new feature type of the loop is exited. In step S609 the next part of the model is read in, if available. Otherwise the method ends with a saved CAD model in step S610.

FIG. 18 shows a flowchart for the detection of bumps. By following the flowchart it is possible to identify a cylinder bump, a cuboid or simple pin bump and three different types of more complex pin bump, as illustrated in the schematics.

At the start, S701 checks for a hole on the surface. If there is no hole, the next face is checked (S702) until there are no faces left to check (S703) and the method ends (S704).

If there is a hole on the surface in step S701, then it is assessed in step S705 whether the hole is concave (indicating a bump). If not, an actual hole has been detected and the process returns to checking the next face in step S702. If the hole is indeed concave, the next check identifies whether there is a single edge (a cylinder bump) in step S706. Step S707 selects smaller bumps or otherwise progresses to the next face. For smaller bumps, a check for an adjacent cylinder face in step S708 reveals other types of bump (such as cones/spheres/parts of spheres) whose detection is not explicitly shown in this method. If they are found (in step S720) then the bump is stored as before in step S710.

If there is an adjacent planar face which is unbroken found in step S709, a simple cylinder bump has been detected and the faces are stored for processing in step S710 before the method continues with the next face. Otherwise, advanced types whose detection is not explicitly set out may be found in step S720.

Returning to step 706, if a single edge is not found then in step S711 the method checks whether there are four linear edges, indicating some kind of cuboid or pin bump. If there are not four linear edges then the process continues in step S712 to process arbitrary holes. This is not shown in further detail. If four linear edges are found, then the next step is S713 to check if the number of edges included in the detected feature is less than the default or user value (indicating a simple pin), if so it is further checked in step S714 whether all four adjacent faces share a top face. In this case pin type 2.1 as shown in the figure has been identified and its faces are stored in step 710. The process continues with the next face. If there is some other geometry identified by step S713, then no bump is found and processing continues to the next face.

Returning to step S714, if adjacent edges do not share a top face, this indicates a more complex pin. The next question in S715 checks for a configuration of pin type 2.2 shown in the schematic. If such a configuration is found, it is stored as a bump with its faces in step S710. If this second configuration is not found, the method goes on in step S716 to search for a different pin configuration shown as pin type 2.3. If pin type 2.3 is found then this is also stored with its faces in steps 710. No further logic is shown, but the skilled reader will understand that the flow chart can be expanded to include further bump types.

### Graphical User Interface (GUI)

The users' ability to add new features was described above. In this section the improved GUI and development environment are described.

FIG. 19 shows an outline of the basic methodology display GUI layout with new elements (words in italic) for adding the functions for the users to add new or edit exiting features.

Selecting the Feature Characteristic option at the “Top Menu Bar” will start up a new window environment for feature creation, editing and development.

FIG. 20 shows an outline of the feature characteristic development window (FCDW). The FCDW environment provides the functions to load and save feature characteristics to the database, create new features and to edit existing ones. It also provides the mechanism to run the feature functions within the FDSW in either debug or non debug mode. Any messages will be output to the message area of FDSW and any 3D model graphic output is to display in parent GUI 3D model display window.

FIG. 20 illustrates a description of each of the feature characteristics, along with an indication of a code or function. In practice, the description need not be included.

Finally, for the avoidance of doubt it is noted that invention embodiments also provide a computer program or a computer program product for carrying out any of the methods described herein, and a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

1. A computer-implemented method of geometric feature detection comprising:
accessing a data file including a geometric model of an object;
accessing an unsuitable feature file including definitions of geometric features which are unsuitable for analysis; and
automatically detecting a defined unsuitable geometric feature included in the object.

2. A method according to claim 1, wherein
a shared hierarchy of feature characteristics is used in the unsuitable feature file for the definitions of at least two unsuitable features, at least a base feature characteristic in the hierarchy being present in the two unsuitable features.

3. A method according to claim 1, wherein
the definitions of unsuitable geometric features are constructed as a hierarchical tree allowing querying with at least some query outcomes representing defined unsuitable geometric features, and wherein
a query as to a base feature characteristic forms a first query leading to a first outcome and a further query as to a further feature characteristic is appended to the first outcome, leading to a further outcome.

4. A method according to claim 3, wherein
automatically detecting includes applying hierarchical queries to the model to check it against the unsuitable geometric features defined in the tree.

5. A method according to any of claim 2, wherein
a base feature characteristic is the footprint of a protrusion, cavity or hole projecting from a surface of the model and preferably wherein
a further feature characteristic is a number of planar surfaces surrounding the footprint of the base feature characteristic on the plane.

6. A method according to claim 5, wherein the unsuitable feature file includes instructions for modification of the unsuitable geometric features.

7. A method according to claim 5, wherein
the unsuitable feature file is stored and/or created separately from a program implementing the detection.

8. A method according to claim 5, further comprising modifying the unsuitable geometric feature after detection to produce a modified model for analysis purposes.

9. A computer-implemented method of defining unsuitable geometric features of a CAD model comprising:
employing a user interface on the computer to access an unsuitable feature file for holding definitions of geometric features which are unsuitable for analysis;
employing the user interface to manually modify the unsuitable feature file to include a definition of a new geometric feature which is unsuitable for analysis; and
storing the modified unsuitable feature file in a database separately from any program implementing a method for detection and modification of the unsuitable geometric feature.

10. A method according to claim 9, wherein the new unsuitable geometric feature is added without access to software code for detection of unsuitable geometric features.

11. A graphical user interface providing a computer-implemented method of defining unsuitable geometric features in a CAD model, wherein the interface is operable:
to access an unsuitable feature file for holding definitions of geometric features which are unsuitable for analysis; and
to allow the user to manually modify the unsuitable feature file to include a definition of a new geometric feature which is unsuitable for analysis; and
to display a representation of the defined unsuitable geometric feature.

12. A graphical user interface according to claim 11, wherein
the manual modification uses text entry to select feature characteristics which are part of the new unsuitable geometric feature to be defined.

13. A graphical user interface according to claim 11, wherein
the manual modification calls pre-prepared functions, which functions define constituent parts of feature characteristics.

14. A graphical interface according to any of claim 11, wherein
the feature characteristics are defined using an outward normal vector in conjunction with basic geometric elements of CAD models.

15. A computer-implemented method of geometric feature detection comprising:
accessing a data file including a geometric model of an object;
using definitions of geometric features which are unsuitable for analysis to automatically detect any defined unsuitable geometric feature included in the object; and optionally
modifying the unsuitable geometric feature to produce a modified model for analysis purposes; wherein
a shared hierarchy of feature characteristics is used for the definitions of at least two unsuitable features, at least a base feature characteristic in the hierarchy being present in the two unsuitable features.

16. A computer program which when executed on a computing device provides the graphical user interface of any of the preceding graphical user interface claims or carries out the method of any of the preceding method claims.

17. A Computer Aided Engineering system comprising input functionality to read in a CAD file and/or unsuitable features file, output functionality to output a modified CAD file and or modified unsuitable features file, and computing capacity operable to carry out the method of any of the preceding claims.
